(19) United States
(12) Patent Application Publication
(10) Pub. No.: US 2022/0221872 A1
(43) Pub. Date: Jul. 14, 2022

(54) INFORMATION PROCESSING DEVICE, INFORMATION PROCESSING METHOD, AND PROGRAM

(71) Applicant: SONY GROUP CORPORATION, Tokyo (JP)

(72) Inventors: Kenichiro OI, Kanagawa (JP); Eisuke NOMURA, Tokyo (JP)

(73) Assignee: SONY GROUP CORPORATION, Tokyo (JP)

(21) Appl. No.: 17/609,539

(22) PCT Filed: Jun. 15, 2020
(86) PCT No.: PCT/JP2020/023351

§ 371 Date: Nov. 8, 2021

(30) Foreign Application Priority Data
Jun. 27, 2019 (JP) 2019-119436

(51) Int. Cl. G05D 1/02

(52) U.S. Cl. CPC G05D 1/0219; G05D 1/0251; G05D 2201/0216; G05D 1/0214; G05D 1/0221

(57) ABSTRACT

There is provided an information processing device, an information processing method, and a program capable of searching for an optimal route for transporting a predetermined object. Provided is a processing unit that generates a mobile object model including an object to be transported and a transport executing object that transports the object, and a three-dimensional shape map of a place to which the object is to be transported, the three-dimensional shape map being based on a captured image of the place, assigns, on the three-dimensional shape map, a label indicating a property of an installed object installed at the place to a position corresponding to the place, and searches for a route on which a target object is to be transported, on the basis of the mobile object model, the three-dimensional shape map, and the label. The present technology can be applied to, for example, an information processing device that performs a route search.

### TECHNICAL FIELD

The present technology relates to an information processing device, an information processing method, and a program, and for example to an information processing device, an information processing method, and a program capable of searching for an appropriate route and presenting the route to a user when transporting a predetermined object.

### BACKGROUND ART

An autonomous robot device can autonomously operate according to a state of a surrounding external environment or an inside of the robot. For example, the robot device can autonomously move by planning a route for detecting an external obstacle and avoiding the obstacle. Patent Document 1 proposes a technique related to route planning.

### CITATION LIST

### Patent Document

Patent Document 1: Japanese Patent Application Laid-Open No. 2006-239844

### SUMMARY OF THE INVENTION

### Problems to be Solved by the Invention

The route is planned so as not to hit the obstacle. There has been a possibility that the route is not an optimal route, because the route is planned to avoid any obstacle regardless of a type of the obstacle.

The present technology has been developed to solve such a problem described above, and is to achieve search of a more optimal route in consideration of a type of an obstacle.

### Solutions to Problems

An information processing device according to one aspect of the present technology includes a processing unit that generates a mobile object model including an object to be transported and a transport executing object that transports the object, and a three-dimensional shape map of a place to which the object is to be transported, the three-dimensional shape map being based on a captured image of the place, assigns, on the three-dimensional shape map, a label indicating a property of an installed object installed at the place to a position corresponding to the installed object, and searches for a route on which the object is to be transported on the basis of the mobile object model, the three-dimensional shape map, and the label.

An information processing method according to one aspect of the present technology includes generating a mobile object model including an object to be transported and a transport executing object that transports the object, and a three-dimensional shape map of a place to which the object is to be transported, the three-dimensional shape map being based on a captured image of the place, assigning, on the three-dimensional shape map, a label indicating a property of an installed object installed at the place to a position corresponding to the installed object, and searching for a route on which the object is to be transported on the basis of the mobile object model, the three-dimensional shape map, and the label.

A program according to one aspect of the present technology allows for executing processing including generating a mobile object model including an object to be transported and a transport executing object that transports the object, and a three-dimensional shape map of a place to which the object is to be transported, the three-dimensional shape map being based on a captured image of the place, assigning, on the three-dimensional shape map, a label indicating a property of an installed object installed at the place to a position corresponding to the installed object, and searching for a route on which the object is to be transported on the basis of the mobile object model, the three-dimensional shape map, and the label.

With an information processing device, information processing method and program according to one aspect of the present technology, a mobile object model including an object to be transported and a transport executing object that transports an object is generated, a three-dimensional shape map having a three-dimensional shape is generated on the basis of a captured image of a place to which the object is to be transported, a label is attached to an installed object installed in a place, and a route on which the object is to be transported is searched for by using the mobile object model, the three-dimensional shape map, and the label.

Note that the information processing device may be an independent device or may be an inner block including one device.

Furthermore, the program can be provided by being transmitted via a transmission medium or by being recorded on a recording medium.

### BRIEF DESCRIPTION OF DRAWINGS

FIG. 1 is a diagram illustrating a configuration of an embodiment of an information processing system to which the present technology is applied.

FIG. 2 is a diagram for describing processing performed by the information processing system.

FIG. 3 is a diagram illustrating a functional configuration example of a terminal.

FIG. 4 is a diagram for describing functions of the terminal.

FIG. 5 is a diagram illustrating another functional configuration example of the terminal.

FIG. 6 is a diagram illustrating another functional configuration example of the terminal.

FIG. 7 is a diagram illustrating another functional configuration example of the terminal.

FIG. 8 is a diagram illustrating another functional configuration example of the terminal.

FIG. 9 is a diagram illustrating another functional configuration example of the terminal.

FIG. 10 is a flowchart for describing operation of the terminal in a first embodiment.

FIG. 11 is a diagram illustrating an example of a screen displayed when a mobile object model is generated.

FIG. 12 is a diagram for describing the mobile object model.

FIG. 13 is a diagram for describing the mobile object model.

FIG. 14 is a diagram for describing a method for converting a 2D label into a 3D label.

FIG. 15 is a diagram for describing how to set the 2D label.

FIG. 16 is a diagram for describing how to set the 3D label.

FIG. 17 is a diagram for describing how to set a start position.

FIG. 18 is a diagram for describing how to set a start position.

FIG. 19 is a diagram for describing a 3D shape map.

FIG. 20 is a diagram for describing the 3D shape map.

FIG. 21 is a diagram for describing the 3D shape map.

FIG. 22 is a diagram for describing height limitation in a case of a human.

FIG. 23 is a diagram illustrating an example of displaying a route search result in the case of a human.

FIG. 24 is a diagram for describing height limitation in a case of a drone.

FIG. 25 is a diagram illustrating an example of displaying a route search result in the case of a drone.

FIG. 26 is a diagram for describing a route search in a case of an installed object.

FIG. 27 is a diagram for describing a route search in a case of a transportable object.

FIG. 28 is a diagram for describing a route search corresponding to a transportable object level.

FIG. 29 is a diagram for describing a route search corresponding to a transportable object level.

FIG. 30 is a diagram for describing an NG area set in a case of a valuable item.

FIG. 31 is a diagram for describing an NG area corresponding to a valuable item level.

FIG. 32 is a diagram for describing a mobile object model.

FIG. 33 is a diagram illustrating an example of displaying a route search result in a case where a mobile object model is changed due to a route.

FIG. 34 is a diagram for describing a route search result in a case where the mobile object model is changed due to a route.

FIG. 35 is a diagram for describing a route search result in a case where the mobile object model is changed due to a route.

FIG. 36 is a diagram for describing a route search result in a case where the mobile object model is changed due to a route.

FIG. 37 is a diagram for describing how to set an entry prohibited area.

FIG. 38 is a diagram for describing a route search in a case where the entry prohibited area is set.

FIG. 39 is a diagram for describing how to set an end position.

FIG. 40 is a flowchart for describing operation of the terminal in a second embodiment.

FIG. 41 is a diagram illustrating another configuration of the information processing system.

FIG. 42 is a diagram for describing a recording medium.

### MODE FOR CARRYING OUT THE INVENTION

Modes for carrying out the present technology (hereinafter, referred to as embodiments) will be described below.

<Configuration Example of System>

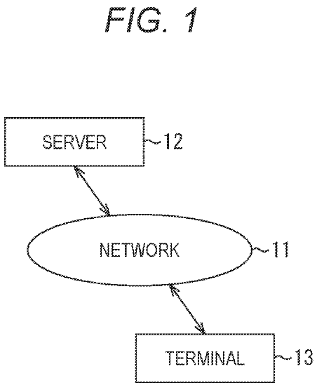

FIG. 1 is a diagram illustrating a configuration example of an embodiment of an information processing system to which the present technology is applied. The information processing system includes a network 11, a server 12, and a terminal 13.

The network 11 is a wire or wireless network that supports, for example, a home network, a local area network (LAN), a wide area network (WAN), a wide area network such as the Internet, or the like. The server 12 and the terminal 13 are configured to be able to exchange data via the network 11.

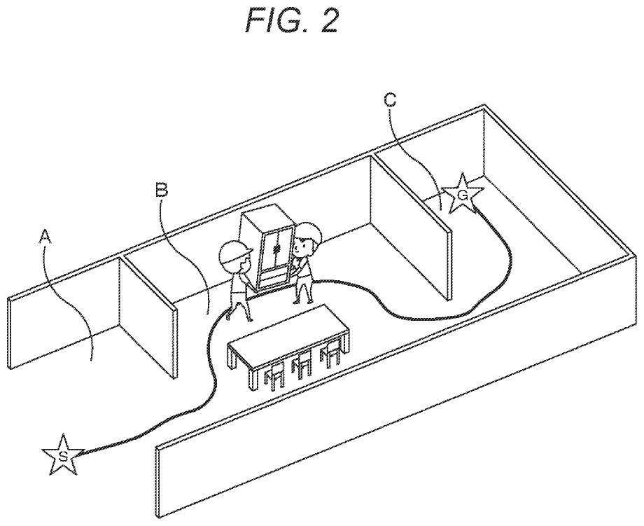

An outline of processing performed by the information processing system illustrated in FIG. 1 will be described. The information processing system creates a three-dimensional map (hereinafter described as a 3D map) as illustrated in FIG. 2, searches for a route suitable for transporting an object of a predetermined size, and presents the searched route to the user.

The 3D map illustrated in FIG. 2 includes a room A, a room B, and a room C, and illustrates a state where a predetermined position in the room A is set as a start position (position denoted by S in the drawing) and a predetermined position in the room C is set as an end position (position denoted by G in the drawing). The 3D map is created by using information acquired by a sensor included in the terminal 13.

The start position and the end position are designated by the user of the terminal 13 with a predetermined method. A route suitable for transporting the predetermined object from the start position to the end position is searched for. In search of the route, a size of the predetermined object and a size of a human carrying the object are considered, and a route on which the object or the human do not hit a wall, an object already placed, or the like, is searched for.

In the example illustrated in FIG. 2, a desk and chairs are installed in the room B. A route avoiding the desk and the chairs is searched for. Furthermore, in a case where an installed object is a transportable object that allows for passing if being transported, such a route may be selected.

The searched route is represented by, for example, a line connecting the start position and the end position as illustrated in FIG. 2, and is presented to the user. Processing related to the search and display of the route, or the like, is executed by the server 12 and the terminal 13 included in the information processing system. Hereinafter, configurations and processing by the server 12 and terminal 13 will be described.

<Configurations of Server and Terminal>

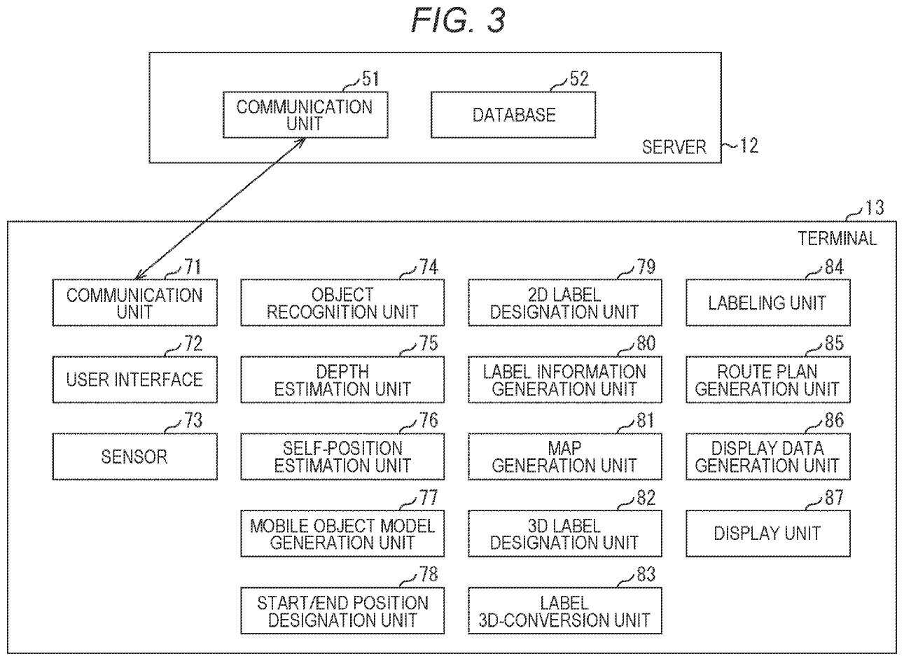

FIG. 3 is a diagram illustrating a functional configuration example of the server 12 and terminal 13 to which the present technology is applied. The server 12 includes a communication unit 51 and a database 52. The communication unit 51 communicates with the terminal 13 via a network 11. The database 52 stores information about weight, size, or the like of a predetermined object to be transported.

The terminal 13 includes a communication unit 71, a user interface 72, a sensor 73, an object recognition unit 74, a depth estimation unit 75, a self-position estimation unit 76, a mobile object model generation unit 77, a start/end position designation unit 78, a 2D label designation unit 79, a label information generation unit 80, a map generation unit 81, a 3D label designation unit 82, a label 3D-conversion unit 83, a labeling unit 84, a route plan generation unit 85, a display data generation unit 86, and a display unit 87.

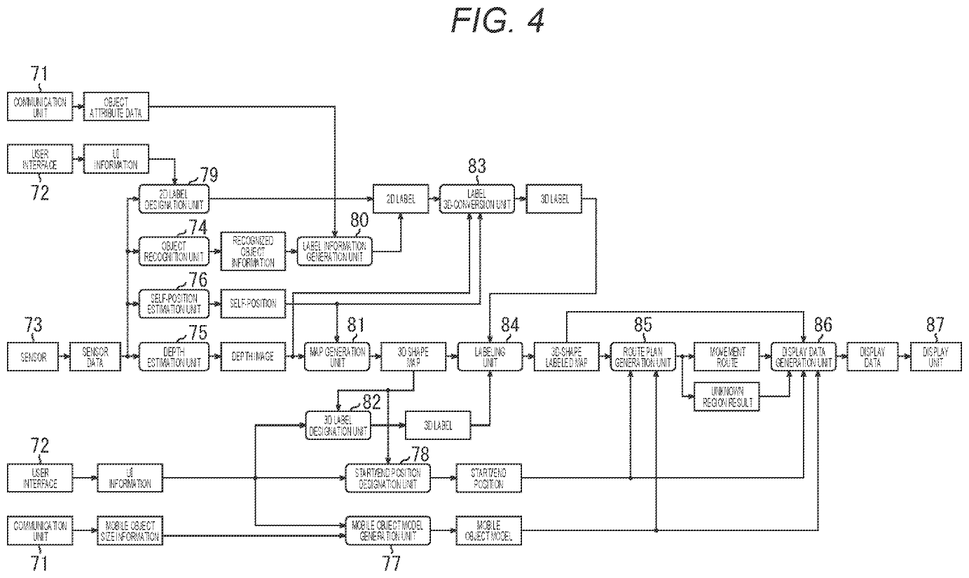

Functions of the respective units in the terminal 13 will be described with reference to FIG. 4. The communication unit 71 communicates with the server 12 via the network 11. The communication unit 71 acquires object attribute data stored in the database 52 of the server 12 and supplies the object attribute data to the label information generation unit 80. The object attribute data is, for example, information indicating whether or not an object placed in a room is transportable, or information indicating whether or not the object is a valuable item.

Furthermore, the communication unit 51 acquires mobile object size information stored in the database 52 of the server 12, and supplies the mobile object size information to the mobile object model generation unit 77. The mobile object size information is information about a size or weight of the object to be transported.

The user interface 72 is an interface for inputting an instruction from a user side, and is, for example, a physical button, a keyboard, a mouse, a touch panel, or the like. UI information supplied to the terminal 13 via the user interface 72 is supplied to the 2D label designation unit 79. The UI information supplied to the 2D label designation unit 79 is data corresponding to the above-described object attribute data the user set to the predetermined object as a transportable object, a valuable item, or the like.

Furthermore, the UI information supplied to the terminal 13 via the user interface 72 is also supplied to the mobile object model generation unit 77. The UI information supplied to the mobile object model generation unit 77 is information indicating that by which the object to be transported is transported, how many people transport the object, or the like, and is information instructed by the user.

Furthermore, the UI information supplied to the terminal 13 via the user interface 72 is also supplied to the start/end position designation unit 78. The UI information supplied to the start/end position designation unit 78 is information regarding a transport start position and transport end position of the object to be transported, and is information instructed by the user.

Furthermore, the UI information supplied to the terminal 13 via the user interface 72 is supplied to the 3D label designation unit 82. The UI information supplied to the 3D label designation unit 82 is information about when the user designates a 3D label. Although the 3D label will be described later, the 3D label is a 2D label attached to a voxel grid. The 2D label is a label describing information set to the predetermined object, the information indicating that the object is a transportable object, a valuable item, or the like.

The sensor 73 captures an image of the object to be transported or acquires information necessary for creating a 3D map. An example of the sensor 73 is a monocular camera in a case where a simultaneous localization and mapping (SLAM) technology is used, SLAM being capable of, by using a monocular camera, simultaneously estimating a position and orientation of the camera and a position of a characteristic point of an object appearing in an input image. Furthermore, the sensor 73 may be a stereo camera, a distance measuring sensor, or the like. Although the sensor 73 is described as one sensor, a plurality of sensors may be included as a matter of course.

Sensor data acquired by the sensor 73 is supplied to the object recognition unit 74, the depth estimation unit 75, the self-position estimation unit 76, and the 2D label designation unit 79.

The object recognition unit 74 analyzes data acquired by the sensor 73 and recognizes an object. The recognized object is a predetermined object already installed in a room, and is a desk, a chair, or the like in a case of description with reference to FIG. 2. The sensor data supplied from the sensor 73 to the object recognition unit 74 is, for example, image data captured by an image sensor, and an object such as a desk or a chair is recognized by analyzing the image data. Examples of a means of analyzing image data include image matching between image data recorded in the server 12 and image data acquired from the sensor 73. The object recognition unit 74 supplies the label information generation unit 80 with information regarding the recognized object as recognized object information.

The depth estimation unit 75 analyzes the data acquired by the sensor 73, estimates depth, and generates a depth image. The depth image from the depth estimation unit 75 is supplied to the map generation unit 81 and the label 3D-conversion unit.

The self-position estimation unit 76 analyzes the data acquired by the sensor 73 and estimates a self position (position of the terminal 13). The self position from the self-position estimation unit 76 is supplied to the map generation unit 81 and the label 3D-conversion unit.

The map generation unit 81 generates a 3D shape map (three-dimensional shape map) by using the depth image from the depth estimation unit 75 and the self position from the self-position estimation unit 76, and supplies the 3D shape map to the labeling unit 84, the 3D label designation unit 82, and the start/end position designation unit 78.

The 2D label designation unit 79 generates a 2D label describing information indicating whether or not the object placed in the room is transportable, or information indicating whether or not the object is a valuable item. The 2D label designation unit 79 generates a 2D label by analyzing the sensor data from the sensor 73, or generates a 2D label on the basis of the UI information from the user interface 72.

The 2D label generated by the 2D label designation unit 79 is supplied to the label 3D-conversion unit 83. The depth image from the depth estimation unit 75 and the self position from the self-position estimation unit 76 are also supplied to the label 3D-conversion unit 83. The label 3D-conversion unit 83 converts the 2D label into a 3D label in a 3D coordinate system.

The 3D label generated by the label 3D-conversion unit 83 is supplied to the labeling unit 84. The labeling unit 84 is also supplied with the 3D shape map from the map generation unit 81 and the 3D label from the 3D label designation unit 82. The labeling unit 84 is supplied with a 3D label from the label 3D-conversion unit 83, and a 3D label from the 3D label designation unit 82.

The 3D label supplied from the label 3D-conversion unit 83 is a label generated from data obtained from the sensor 73, and the 3D label supplied from the 3D label designation unit 82 is a label generated according to an instruction from the user.

The 3D label designation unit 82 is supplied with the 3D shape map from the map generation unit 81 and the UI information from the user interface 72. The 3D label designation unit 82 generates a 3D label for an object on the 3D shape map, the object corresponding to the object instructed by the user, and supplies the labeling unit 84 with the 3D label.

The labeling unit 84 attaches the 3D label supplied from the label 3D-conversion unit 83 or the 3D label supplied from the 3D label designation unit 82 to the object on the 3D shape map.

A 3D-shape labeled map is generated by the labeling unit 84 and supplied to the route plan generation unit 85. The route plan generation unit 85 is also supplied with information regarding the start position and end position from the start/end position designation unit 78, and information about a mobile object model from the mobile object model generation unit 77.

The start/end position designation unit 78 is supplied with the UI information from the user interface 72, and the 3D shape map from the map generation unit 81. On the 3D shape map, the start/end position designation unit 78 designates a transport start position designated by the user (position indicated by S in FIG. 2) and a transport end position (position indicated by G in FIG. 2). Information about the designated start position and end position is supplied to the route plan generation unit 85 and the display data generation unit 86.

The mobile object model generation unit 77 is supplied with the mobile object size information supplied from the server 12 via the communication unit 71 and the UI information from the user interface 72. The mobile object model generation unit 77 generates a mobile object model having a size in consideration of the size of the object to be transported described with reference to FIG. 2 and the size of a human as an example of a transport executing object that performs transport. The generated mobile object model is supplied to the route plan generation unit 85 and the display data generation unit 86.

The route plan generation unit 85 functions as a search unit that searches for a route on which the mobile object model supplied from the mobile object model generation unit 77 can move from the start position to the end position that are supplied from the start/end position designation unit 78. At a time of the search, on the 3D-labeled map supplied from the labeling unit 84, a route that avoids a region to which the 3D label is attached is searched for. Note that, as will be described later, according to information described in the 3D label, an area of a region to be avoided is set, or a route to be passed without being avoided is searched for.

The route plan generation unit 85 generates and supplies the display data generation unit 86 with a movement route and an unknown region result. There are two types of 3D shape maps, which are a known region and an unknown region. The known region is a scanned region, and the unknown region is an unscanned region. For example, when confirming the presented route, the user may think that there may be another good route. In such a case, there is a possibility that a new route can be presented by additionally scanning an unscanned region.

Accordingly, it is possible to present the user with an unknown region, and prompt the user to perform additional scanning as necessary. The unknown region result output from the route plan generation unit 85 may be always output together with the movement route, or may be output when an instruction is provided from the user, when a predetermined condition is satisfied, or the like.

The display data generation unit 86 is supplied with the movement route and an unknown region result from the route plan generation unit 85, the information about the designated start position and end position from the start/end position designation unit 78, and the mobile object model from the mobile object model generation unit 77. The display data generation unit 86 generates display data for displaying, on the display unit 87, an image in which the route, the start position, and the end position are drawn on the 3D map.

The display data for which an image as illustrated in FIG. 2 is displayed on the display unit 87 is generated. The mobile object model may also be displayed as in the example illustrated in FIG. 2 in which a mobile object model is displayed. Furthermore, the unknown region may also be displayed as necessary.

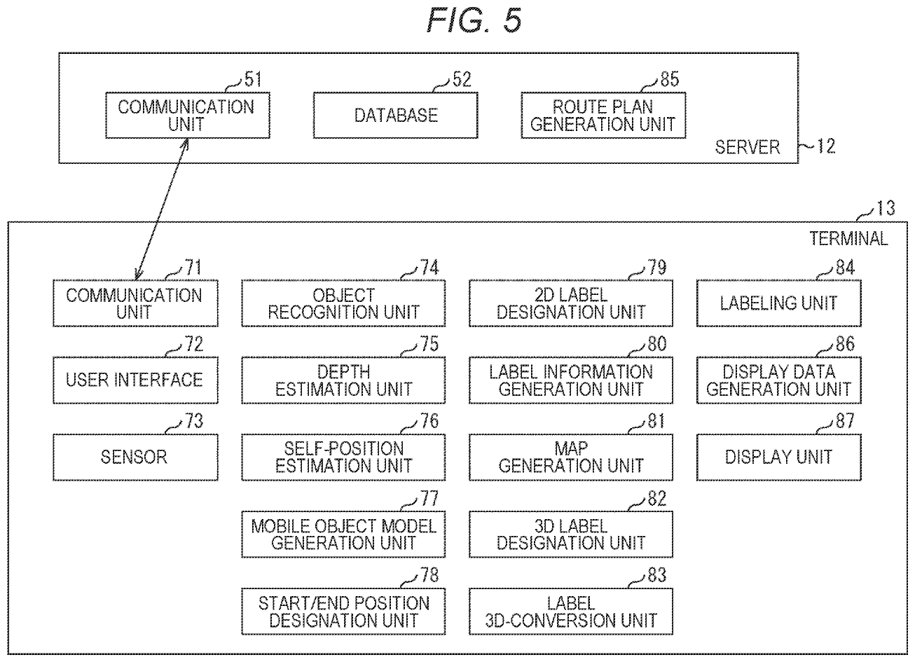

The terminal 13 has functions as illustrated in FIGS. 3 and 4, and presents a route to the user by performing processing. Although the description will be continued in the following description assuming that the terminal 13 has the main functions as illustrated in FIG. 3, the present technology can also be applied to a configuration in which the server 12 includes some of the functions, as illustrated in FIGS. 5 to 9.

FIG. 5 is a diagram illustrating another configuration example of the server 12 and terminal 13. The configuration illustrated in FIG. 5 is different from the configuration illustrated in FIG. 3 in that the route plan generation unit 85, which is included in the terminal 13 in the configuration illustrated in FIG. 2, is included in the server 12 in the configuration illustrated in FIG. 5.

Processing performed by the route plan generation unit 85 may be performed by a device having high processing capability, which is the server 12 in this case, because there is a possibility that an amount of processing increases. Moreover, because an amount of information to be stored increases according to the amount of processing, the server 12 may include a function that requires storage capacity.

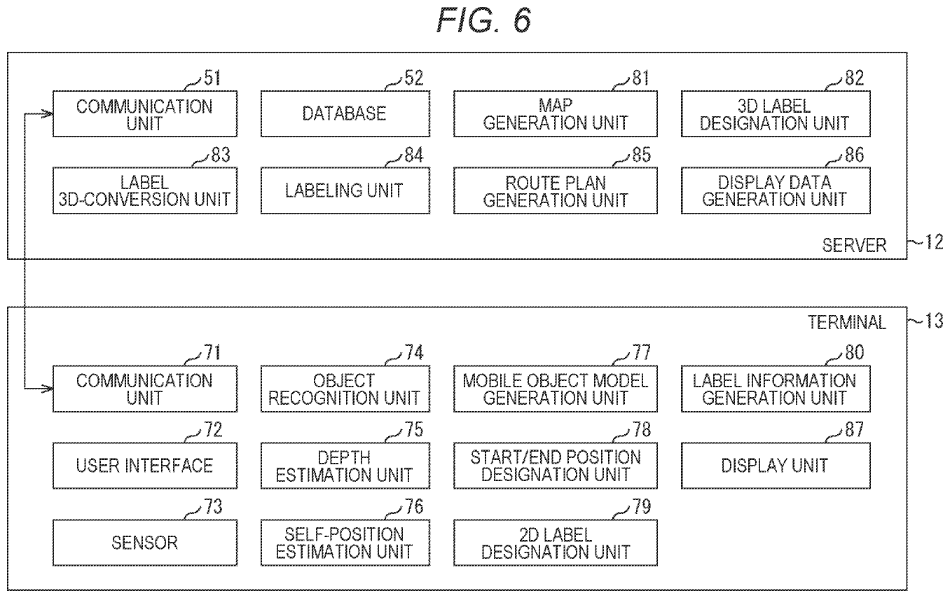

FIG. 6 is a diagram illustrating a configuration example of the server 12 and the terminal 13 in a case where the server 12 includes functions that may increase an amount of processing and require large storage capacity. The server 12 illustrated in FIG. 6 includes the map generation unit 81, the 3D label designation unit 82, the label 3D-conversion unit 83, the labeling unit 84, and the display data generation unit 86, in addition to the communication unit 51, the database 52, and the route plan generation unit 85.

Because there is a possibility that a large amount of memory is required for processing by the map generation unit 81 and the subsequent processing, the server 12 having storage capacity larger than storage capacity of the terminal 13 may include a function that performs the processing by the map generation unit 81 and the subsequent processing.

Moreover, the server 12 may include the functions of the terminal 13. Because the terminal 13 is carried by the user and is used when scanning a place in which a route is desired to be searched for or when capturing an image of an object to be transported, and because the terminal 13 is used when presenting a searched route to the user, the terminal 13 may be configured to mainly have such functions.

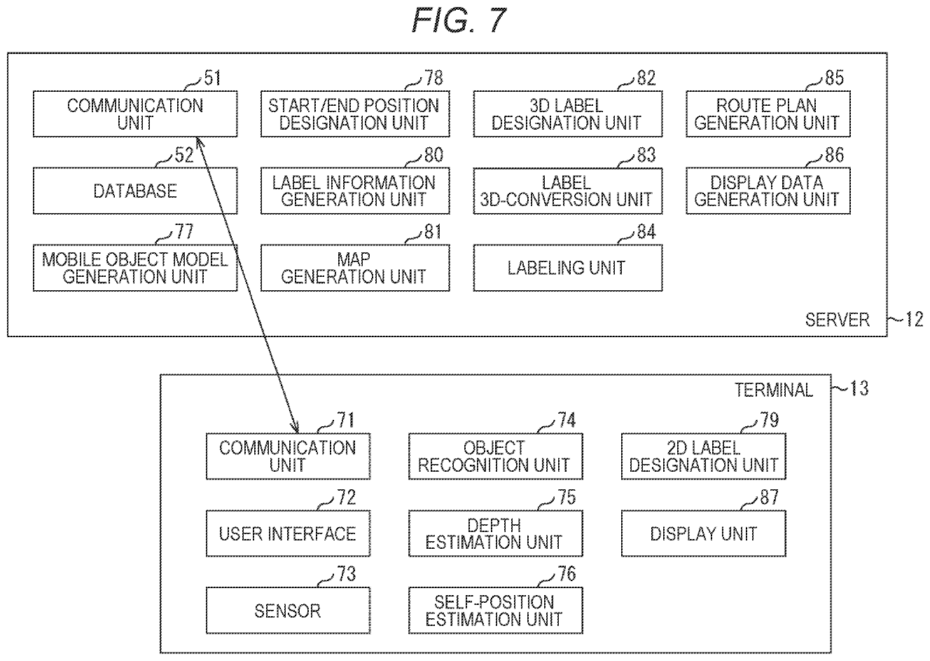

FIG. 7 is a diagram illustrating another configuration example of the server 12 and terminal 13. The configuration of the terminal 13 illustrated in FIG. 7 is a configuration in which the sensor 73 and the function of processing the sensor data obtained by the sensor 73 are left on the terminal 13. The terminal 13 includes the communication unit 71, the user interface 72, the sensor 73, the object recognition unit 74, the depth estimation unit 75, the self-position estimation unit 76, the 2D label designation unit 79, and the display unit 87.

The server 12 includes the communication unit 51, the database 52, the mobile object model generation unit 77, the start/end position designation unit 78, the label information generation unit 80, the map generation unit 81, the 3D label designation unit 82, the label 3D-conversion unit 83, the labeling unit 84, the route plan generation unit 85, and the display data generation unit 86.

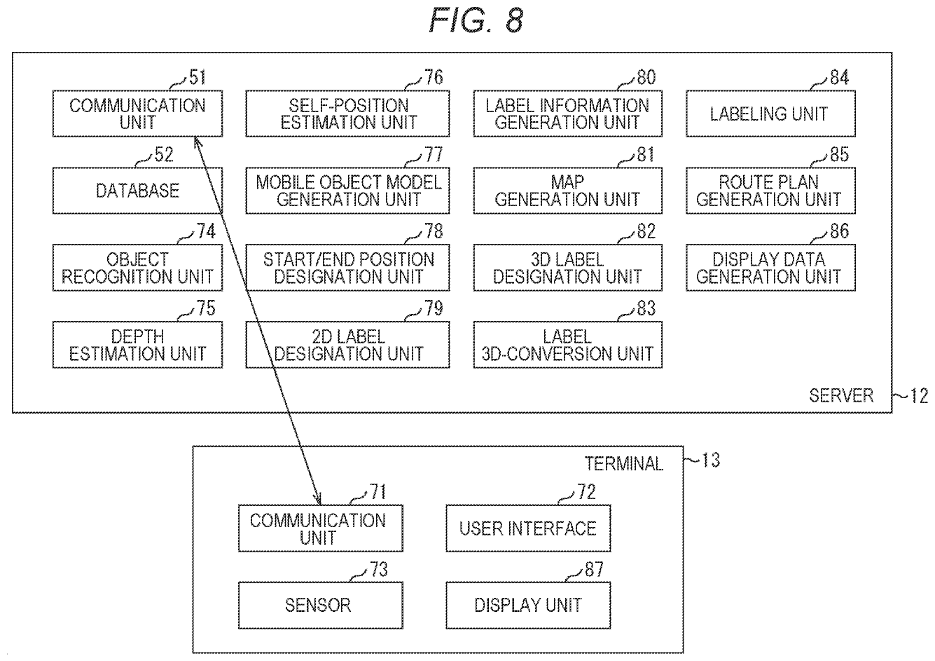

Moreover, as illustrated in FIG. 8, the server 12 may have main functions. The server 12 includes the communication unit 51, the database 52, the object recognition unit 74, the depth estimation unit 75, the self-position estimation unit 76, the mobile object model generation unit 77, the start/end position designation unit 78, the 2D label designation unit 79, the label information generation unit 80, the map generation unit 81, the 3D label designation unit 82, the label 3D-conversion unit 83, the labeling unit 84, the route plan generation unit 85, and the display data generation unit 86.

The terminal 13 includes the communication unit 71, the user interface 72, the sensor 73, and the display unit 87. Such a configuration of the terminal 13 is a function also having a portable terminal such as a smartphone, and an existing smartphone can perform part of the processing using the present technology. In other words, the present technology can be provided as a cloud service, and in a case where the present technology is provided as a cloud service, an existing device such as a smartphone can be used as a part of the system.

Note that, although configurations of the server 12 and terminal 13 have been described as examples here, a device such as a personal computer (PC) can be interposed between the server 12 and the terminal 13. For example, a system configuration is possible in which the terminal 13 has the functions as illustrated in FIG. 8, the server 12 has the configuration as illustrated in FIG. 3 (configuration including the communication unit 51 and the database 52), and the PC has other functions.

In this case, the terminal 13 and the PC communicate with each other, and the PC communicates with the server 12 as necessary. That is, here, although the description will be continued by taking a case where the terminal 13 is configured as one device as an example, the terminal 13 may be a device including a plurality of devices.

Furthermore, although cases where the server 12 includes a part of the functions of the terminal 13 have been described as examples in FIGS. 5 to 8, the terminal 13 may have the function of the server 12. Although not illustrated, the terminal 13 may have the database 52 included in the server 12.

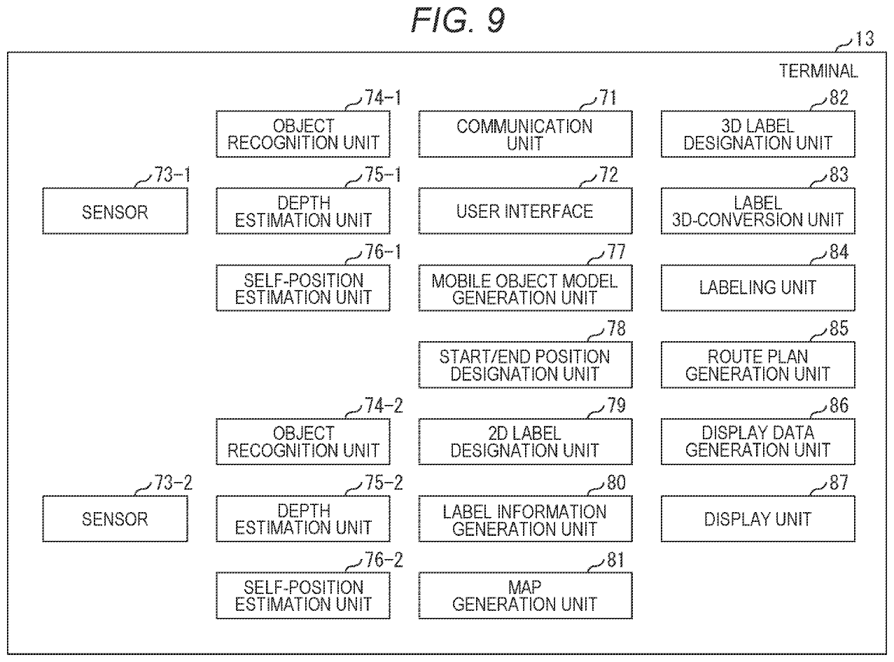

Moreover, the terminal 13 may have a configuration as illustrated in FIG. 9. The terminal 13 illustrated in FIG. 9 includes a plurality of sensors 73 and functions of processing data obtained by each of the sensors 73. Specifically, the terminal 13 illustrated in FIG. 9 includes two sets of the sensors 73, object recognition units 74, depth estimation units 75, and self-position estimation units 76.

The terminal 13 illustrated in FIG. 9 includes a sensor 73-1, an object recognition unit 74-1 that processes sensor data obtained by the sensor 73-1, a depth estimation unit 75-1, and a self-position estimation unit 76-1. Furthermore, the terminal 13 illustrated in FIG. 9 includes a sensor 73-2, an object recognition unit 74-2 that processes sensor data obtained by the sensor 73-2, a depth estimation unit 75-2, and a self-position estimation unit 76-2.

Thus, the terminal 13 may include the plurality of sensors 73 and be configured to process data obtained by the respective sensors 73. By including the plurality of sensors 73, for example, images of a front and rear can be simultaneously captured and processed. Furthermore, for example, it is possible to capture and process images of a wide area pf a left direction and a right direction at a time.

Furthermore, the sensor 73-1 and the sensor 73-2 may be different types of sensors, and the terminal 13 may be configured to process data obtained by the respective sensors 73. For example, the sensor 73-1 may be used as a distance measuring sensor to acquire a distance to an object, and the sensor 73-2 may be used as a global positioning system (GPS) to acquire an own position.

The configurations of the server 12 and terminal 13 illustrated here are merely examples, and are not description indicating limitation. In the following description, the description will be given taking the configuration of the server 12 and terminal 13 illustrated in FIG. 3 as an example.

<Processing by Terminal>

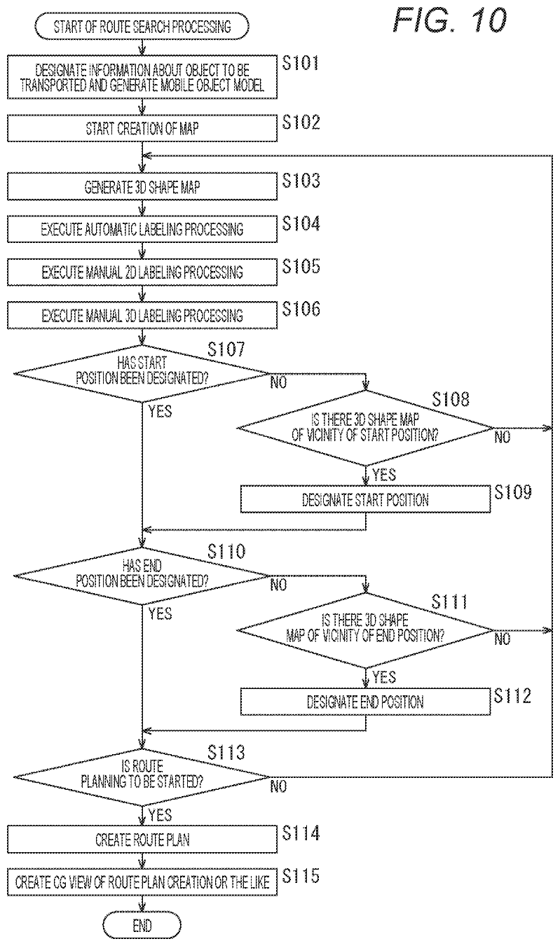

Processing related to route search performed by the terminal 13 will be described with reference to a flowchart in FIG. 10.

In Step S101, information about the object to be transported is designated, and a mobile object model is generated. The information about the object to be transported is a size (dimensions of length, width, and depth), weight, accompanying information, and the like. The accompanying information is, for example, information indicating that the object is prohibited from being upside down during a transport, the object is a fragile object, or the like.

The information about the object to be transported (hereinafter described as a transport target object as appropriate) is acquired by, for example, the sensor 73 capturing an image of the transport target object and the captured image data being analyzed.

The user captures an image of the transport target object by using the terminal 13. Image data of the captured image is analyzed by the mobile object model generation unit 77. The mobile object model generation unit 77 transmits information about the transport target object identified as a result of the analysis to the server 12 via the communication unit 71. In a case where the server 12 receives information about the transport target object, the server 12 reads, from the database 52, information that matches the information about the transport target object.

The database 52 stores the transport target object, and a size, weight, and accompanying information of the transport target object in association with each other. The server 12 transmits the information read from the database 52 to the terminal 13. The terminal 13 acquires the information about the transport target object by receiving the information from the server 12.

The server 12 may be a server of a search site. In the server 12, a website page on which the transport target object is posted may be identified by image retrieval, and the information about the transport target object may be acquired by being extracted from the page.

Options of transport target object may be displayed in the display unit 87 of the terminal 13, and a transport target object may be specified by the user selecting the transport target object from the options. For example, transport target objects may be displayed in a list form, and a transport target object may be specified by the user searching the list or inputting a name.

Furthermore, information about a size, weight, or the like of the transport target object may be acquired by being input by the user.

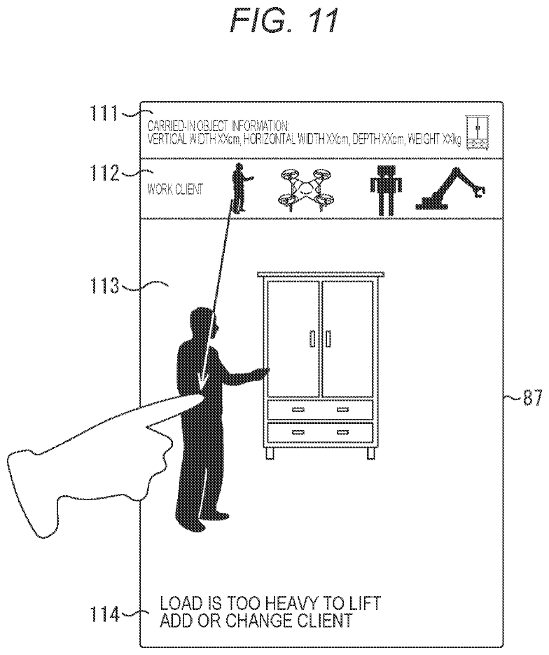

When the information about a transport target object is acquired, a mobile object model is generated. A user interface of when a mobile object model is generated will be described with reference to FIG. 11.

FIG. 11 is a diagram illustrating an example of a user interface (hereinafter described as a UI screen as appropriate) displayed in the display unit 87 when a mobile object model is generated. On an upper part of the UI screen, a transport target object information display field 111 that displays information about a transport target object is displayed. The transport target object information display field 111 displays information regarding a size, such as a vertical width, horizontal width, or depth, of the transport target object, and a picture representing the transport target object. The UI screen illustrated in FIG. 11 exemplifies a case where the transport target object is a chest.

Displayed below the transport target object information display field 111 is a transport target object display field 112 displaying transport executing objects that execute transport of the transport target object. The transport executing object display field 112 is provided as a field for selection of a transport executing object that actually performs transport. The transport executing object display field 112 illustrated in FIG. 11 displays pictures representing a human, a drone, a robot, and a crane as transport executing objects. Examples of the mobile object model include a human, a drone, a robot, a crane, and the like as illustrated in the display field 112 illustrated in FIG. 11.

A work field 113 is provided below the transport executing object display field 112. The work field 113 displays a picture representing a transport target object (described as a 3D model). The UI screen illustrated in FIG. 11 displays a picture of a chest as the 3D model. The user selects a transport executing object displayed in the transport executing object display field 112 by, for example, drag and drop. The UI screen illustrated in FIG. 11 illustrates a case where a human is selected as the transport executing object.

A message display field 114 is provided below the work field 113. In the message display field 114, a message is displayed as necessary. For example, when a transport executing object is not selected, a message “SELECT TRANSPORT EXECUTING OBJECT.” is displayed.

Furthermore, when it is judged that transport by using a selected transport executing object is difficult, a message notifying the user of the fact is displayed. For example, in the example illustrated in FIG. 11, a message “LOAD IS TOO HEAVY TO LIFT. ADD OR CHANGE TRANSPORT EXECUTING OBJECT.” is displayed. Such a message is displayed when it is judged that the transport target object is heavier than a maximum load that the transport executing object can carry, after comparison of weight of the transport target object and the maximum load that the transport executing object can carry.

In order to display such judgment or message, weight of the transport target object is acquired. Furthermore, the maximum load the transport executing object can carry may also be acquired from the database 52 or may be preset (held by the mobile object model generation unit 77).

Furthermore, after the transport executing object is selected, a message “ARE YOU SURE THIS IS OK?” and a “COMPLETE” button may be displayed. Processing for setting such a mobile object model is performed for each transport target object.

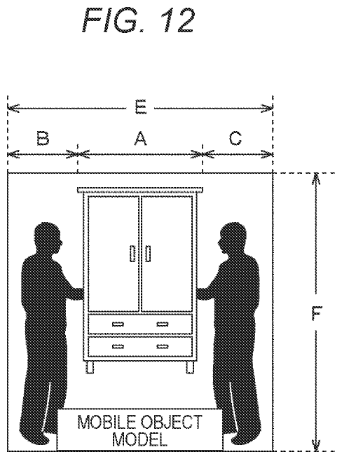

A mobile object model will be described with reference to FIG. 12. The example illustrated in FIG. 12 represents a mobile object model generated in a case where a transport executing object is set by using a UI image illustrated in FIG. 11. The mobile object model is a model having a size in consideration of a size of the transport target object and a size of the transport executing object that executes transport.

The example illustrated in FIG. 12 illustrates a case where the transport target object is a chest and the transport executing object is a human. Furthermore, the UI image illustrated in FIG. 11 illustrates a case where the user has added a human, corresponding to the message “ADD OR CHANGE TRANSPORT EXECUTING OBJECT”. That is, a case where two humans are selected as transport executing objects is illustrated.

A size of the mobile object model in the case illustrated in FIG. 12 is a size obtained by adding sizes of a transport target object A, a human B, and a human C. A horizontal width E of the mobile object model is a value obtained by adding a horizontal width A of the transport target object A, a width B of the human B facing a direction when lifting the chest, which is sideways in this case, and a width C of the human C, likewise.

Furthermore, a vertical width F of the mobile object model is a size of when the human B and the human C lift the transport target object A. For example, on the UI screen illustrated in FIG. 11, after setting the transport executing object, the user moves the displayed 3D model of the transport target object in a vertical direction to set which parts of the load the humans will hold. On the basis of the set state, the vertical width F may be set.

Alternatively, as illustrated in FIG. 12, the mobile object model generation unit 77 may create a state in which the humans are lifting the chest, and the vertical width F may be set. A relative positional relation between the humans and the transport target object as illustrated in FIG. 12 may be set by the user or may be set by the mobile object model generation unit 77.

Although the horizontal width E and the vertical width F are illustrated in FIG. 12, a depth G is set in a same manner as the horizontal width E and the vertical width F are set. Thus, the mobile object model is a model having a size in consideration of a size of the transport target object and a size of the transport executing object. In this case, the mobile object model can be defined as a cube with the horizontal width E, the vertical width F, and the depth G.

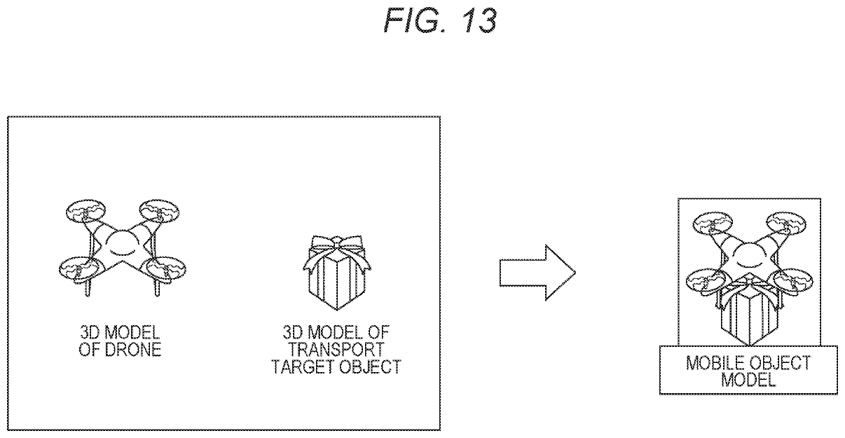

As referred to the UI screen illustrated in FIG. 11 again, the transport executing object display field 112 displays a drone, a robot, or the like, in addition to the human. FIG. 13 illustrates a mobile object model when the drone is selected from the transport executing object display field 112.

As referred to FIG. 13, a 3D model of the drone and a 3D model of the transport target object are acquired as mobile object size information. The mobile object model generation unit 77 creates a state where the drone holds the transport target object, simulatively creates a cube surrounding the state where the drone holds the transport target object, and sets a size of the cube as the size of the mobile object model.

The description will return to description with reference to the flowchart illustrated in FIG. 10. When a mobile object model is generated in Step S101, the processing proceeds to Step S102.

In Step S102, creation of a map is started. The creation of the map is started when, for example, the user moves to vicinity of the transport start position and instructs to start create a map (search for a route) in the vicinity of the transport start position.

In Step S103, a 3D shape map is created. The 3D shape map is generated by the map generation unit 81. As referred to FIG. 4 again, the map generation unit 81 generates a 3D shape map by using the depth image supplied from the depth estimation unit 75 and the self position supplied from the self-position estimation unit 76.

For example, in a case where the sensor 73 is a stereo camera, a three-dimensional shape map can be created from a depth image obtained from the stereo camera and a camera position (estimated self position) by SLAM.

SLAM is a technology for simultaneously performing self-position estimation and map creation on the basis of information acquired from various sensors, and is a technology utilized for an autonomous mobile robot or the like. By using SLAM, self-position estimation and map creation can be performed, and a 3D shape map can be generated by combining the created map and depth image.

For self-position estimation, a means described in the following Document 1 can be applied to the present technology. Furthermore, for creation of a 3D shape map, a means described in the following Document 2 can be applied to the present technology.
Document 1: Raul Mur-Artal and Juan D. Tardos. ORB-SLAM2: an Open-Source SLAM System for Monocular, Stereo and RGB-D Cameras. IEEE Transactions on Robotics, vol. 33, no. 5, pp. 1255-1262, 2017.
Document 2: Andert, Franz. “Drawing stereo disparity images into occupancy grids: Measurement model and fast implementation.” Intelligent Robots and Systems, 2009. IROS 2009. IEEE/RSJ International Conference on. IEEE, 2009.

Note that a means other than SLAM may be used for the self-position estimation, or a means other than the means described in Document 2 may be used for the creation of the 3D shape map, and the present technology can be applied without being limited to these means.

The user carries the terminal 13 and moves around while capturing an image of a place to which the transport target object is desired to be transported. By an image being captured, sensor data is obtained by the sensor 73, the depth estimation unit 75 generates a depth image by using the sensor data, and the self-position estimation unit 76 estimates a self position.

For example, operation of an image capture button by the user for start of image capturing may be used as a trigger for starting the map creation in Step S102.

In Step S104, automatic labeling processing is executed. Here, “automatic” means processing is performed not on the basis of an instruction from the user but performed in the terminal 13, and is an antonym to “manual”.

In the present embodiment, the labeling is processing performed by the terminal 13 without an instruction from the user, or processing performed on the basis of an instruction from the user. Furthermore, the present embodiment is also configured such that a user can change or correct a label once attached.

The automatic labeling processing executed in Step S104 is performed by the label information generation unit 80, the label 3D-conversion unit 83, and the labeling unit 84. Refer to FIG. 4 again. The label information generation unit 80 generates a 2D label by using the recognized object information recognized by the object recognition unit 74 and the object attribute data transmitted from the server 12 via the communication unit 71.

The 2D label is a label on which information indicating that the recognized object is a transportable object, a valuable item, or the like, is described. Furthermore, a name or the like of the recognized object may also be written. Because a recognized object is an object installed in a place to which the transport target object is to be transported, for example, a room or the like, hereinafter the object will be described as an installed object as appropriate.

The transportable object is an installed object such as furniture or home electrical appliance installed in a room, and is a movable installed object. Among transportable objects, there is a difference in that a heavy or large object is difficult to move, while a light or small object is easy to move. Accordingly, a level of a transportable object is set according to transportability of the transportable object. Although description will be continued here assuming that an object with a higher level is more transportable, that is, easier to move, the scope of the present technology also includes a case where an object with a lower level is more transportable.

The valuable item is an installed object that is not desired to be broken, damaged, or the like. A level can also be set for the valuable item. As will be described later, when searching for a route, a route that is distant from an installed object set as a valuable item is searched for. At a time of the search, the level is referred to as a condition for setting how far the valuable item and the route are away from each other. Here, description will be continued assuming that a route is searched for at a farther position for a higher level.

Although description will be continued here by exemplifying a case where there are information of a transportable object and information of a valuable item as information about a 2D label, another piece of information may also be set as a matter of course.

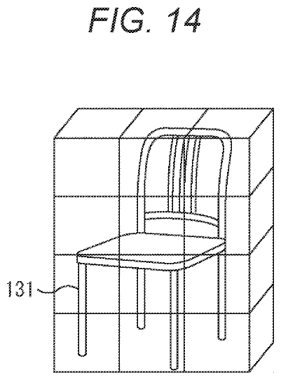

The description will return to the description with reference to the flowchart in FIG. 10. In Step S104, automatic labeling processing is executed, by which a 2D label is generated for the installed object as described above. Moreover, processing of attaching the generated 2D label to a corresponding installed object on the 3D shape map is executed. For example, as illustrated in FIG. 14, in a case where a chair is an installed object 131, the installed object 131 is recognized in units of a plurality of voxels.

The depth image obtained by the stereo camera (sensor 73) and the estimation result of the self position of the terminal 13 are used to determine a size of the installed object 131, and a cube having the size is divided into voxels. For example, in the example illustrated in FIG. 14, a chair is divided into nine voxels. The 2D label is attached to each of the nine voxels.

For example, because the chair is a transportable object, information such as “TRANSPORTABLE OBJECT” is described as information about the 2D label. It is possible to indicate that a voxel is a transportable object by the 2D label on which transportable object information is described being attached to the voxel. The voxels are arranged in three dimensions of a vertical direction, a horizontal direction, and a depth direction, and therefore, for example as illustrated in FIG. 14, by a 2D label being attached to the nine voxels, an object represented by the nine voxels is labeled as a transportable object. Such processing is processing of converting a 2D label, which is a two-dimensional label, into a 3D label, which is a three-dimensional label.

Thus, the processing of converting the 2D label into the 3D label is executed. The label 3D-conversion unit 83 generates a 3D label indicating a transportable object or a valuable item in a three-dimensional coordinate system by using the depth image from the depth estimation unit 75, the self position from the self-position estimation unit 76, and the 2D label from the 2D label designation unit 79. The generated 3D label is supplied to the labeling unit 84.

The labeling unit 84 generates a 3D-labeled map by integrating the 3D shape map supplied from the map generation unit 81 and the 3D label supplied from the label 3D-conversion unit 83. The labeling unit 84 identifies a position of the installed object 131 on the 3D shape map, and generates a 3D-labeled map by attaching the 3D label to the installed object 131 at the identified position.

Thus, the 3D shape map is generated when the user is capturing an image, by using the sensor 73 (camera), of a place to which the transport target object is desired to be transported. Furthermore, when the installed object 131 appears in the captured image, a 2D label is generated, and the generated 2D label is associated with the installed object 131. The 3D-labeled map is a map of 3D shape, and is a map to which information, such as whether the installed object is a transportable object or valuable item, is assigned.

The processing proceeds to Step S105 after the automatic labeling processing is performed in Step S104 (FIG. 10). In Step S105, manual 2D labeling processing is executed. Furthermore, in Step S106, manual 3D labeling processing is executed. The manual 2D labeling processing and the manual 3D labeling processing executed in Steps S105 and S106 are processing executed when processing equivalent to automatic labeling processing is executed on the basis of an instruction from the user in Step S104.

In a case where the automatic labeling processing is performed with high accuracy in Step S104, where there is no instruction from the user, or the like, the processing in Steps S105 and S106 may be omitted. Furthermore, it may be processing executed in a case where the user changes (corrects) the label attached in the automatic labeling processing in Step S104, and can be interrupt processing.

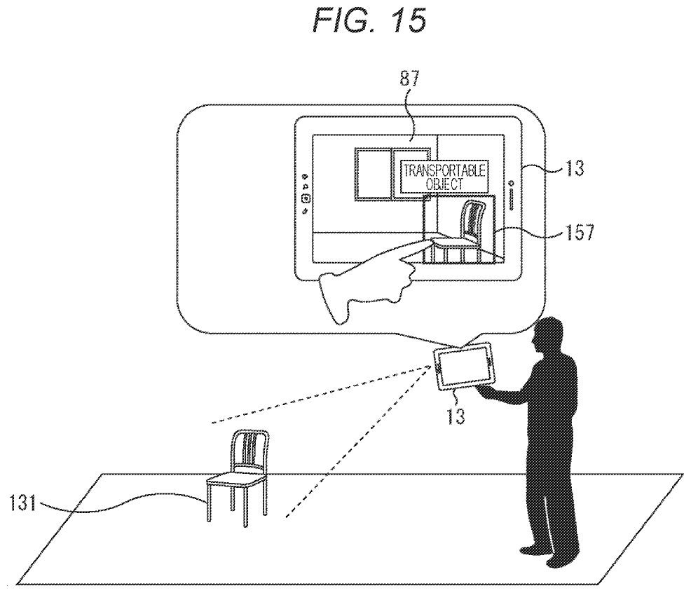

In Step S105, the 2D label designation unit 79 designates a 2D label on the basis of the UI information from the user interface 72. The user interface 72 of when this processing is executed will be described with reference to FIG. 15.

The user captures an image of the installed object 131 by using the terminal 13. At this time, the installed object 131 is displayed on the display unit 87 of the terminal 13. The user performs predetermined operation such as touching the installed object 131 displayed on the screen. That is, the user touches the displayed installed object 131 when the image of the installed object 131 is captured by the display unit 87 or when the user wishes to add information, such as whether the installed object is a transportable object or valuable item, to the installed object 131.

When the installed object 131 is touched, a frame 151 surrounding the installed object 131 is displayed. The frame 151 may be configured to be changed in size by the user. Furthermore, when the frame 151 is displayed, “TRANSPORTABLE OBJECT” may be displayed as illustrated in FIG. 15.

When the installed object 131 is selected by the user, it is determined that the selection is selection for setting whether the object is a transportable object or a valuable item, a mechanism is provided in which the user can select an option such as “TRANSPORTABLE OBJECT” or “VALUABLE ITEM”.

Thus, the user sets the installed object 131 corresponding to a transportable object or a valuable item. That is, a 2D label is set by the user. The 2D label designation unit 79 generates a 2D label by analyzing UI information obtained by such operation by the user, and supplies the label 3D-conversion unit 83 with the generated 2D label.

The label 3D-conversion unit 83 performs processing of converting the 2D label into a 3D label, as in a case of the automatic labeling processing in Step S104 described above, and supplies the labeling unit 84 with the 3D label. The labeling unit 84 performs, as in the case described above, processing of integrating the 3D shape map and the 3D label, generating and supplying the route plan generation unit 85 with a 3D-shape labeled map.

Thus, the 2D label may be designated by the user. Furthermore, a 3D-shape labeled map may be generated on the basis of the 2D label designated by the user.

The manual 2D labeling processing executed in Step S105 is a case of attaching the 2D label in a shooting screen when, for example, creating a 3D shape map and when an image of a place to which the transport target object is desired to be transported is captured. Furthermore, a 3D-shape labeled map is generated on the basis of the attached 2D label.

The manual 3D labeling processing executed in Step S106 to be described next is different from processing in Step S105 in that the user selects, while viewing the generated 3D shape map, an installed object to which a label is to be attached, although basically generating up to a 3D-shape labeled map on the basis of the instruction from the user.

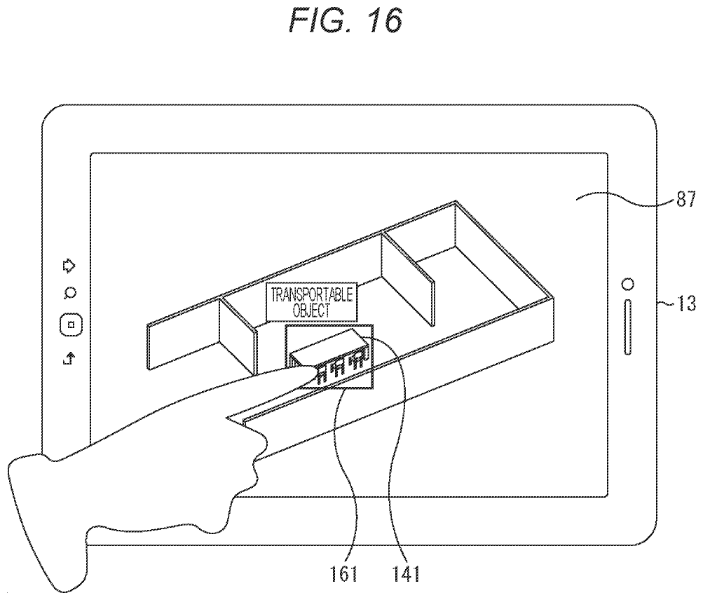

In Step S106, manual 3D labeling processing is executed. In Step 3106, the 3D label designation unit 82 designates a 3D label on the basis of the UI information from the user interface 72. The user interface 72 of when this processing is executed will be described with reference to FIG. 16.

FIG. 16 is a diagram illustrating an example of a screen displayed on the display unit 87 of the terminal 13 when a 3D label is designated by the user. The display unit 87 displays a 3D shape map created at that point of time. Furthermore, a desk and chairs are displayed as an installed object 141. The user performs predetermined operation such as touching the installed object 141 displayed on the screen. That is, the user touches the displayed installed object 141 when the image of the installed object 141 is captured by the display unit 87 or when the user wishes to add information, such as whether the installed object is a transportable object or valuable item, to the installed object 141.

When the installed object 141 is touched, a frame 161 surrounding the installed object 141 is displayed. The frame 161 may be configured to be changed in size by the user. Furthermore, when the frame 161 is displayed, “TRANSPORTABLE OBJECT” may be displayed as illustrated in FIG. 16. When the installed object 141 is selected by the user, it is determined that the selection is selection for setting whether the object is a transportable object or a valuable item, a mechanism is provided in which the user can select an option such as “TRANSPORTABLE OBJECT” or “VALUABLE ITEM”.

Thus, the user sets the installed object 141 corresponding to a transportable object or a valuable item. That is, a 3D label is set by the user. The 3D label designation unit 82 generates a 3D label by analyzing UI information obtained by such operation by the user, and supplies the labeling unit 84 with the generated 3D label.

The labeling unit 84 performs, as in the case described above, processing of integrating the 3D shape map and the 3D label, generating and supplying the route plan generation unit 85 with a 3D-shape labeled map.

Thus, the 3D label may be designated by the user.

Thus, the user can set a 2D label while referring to a captured image. Furthermore, the user can also set a 3D label while referring to a generated 3D shape map.

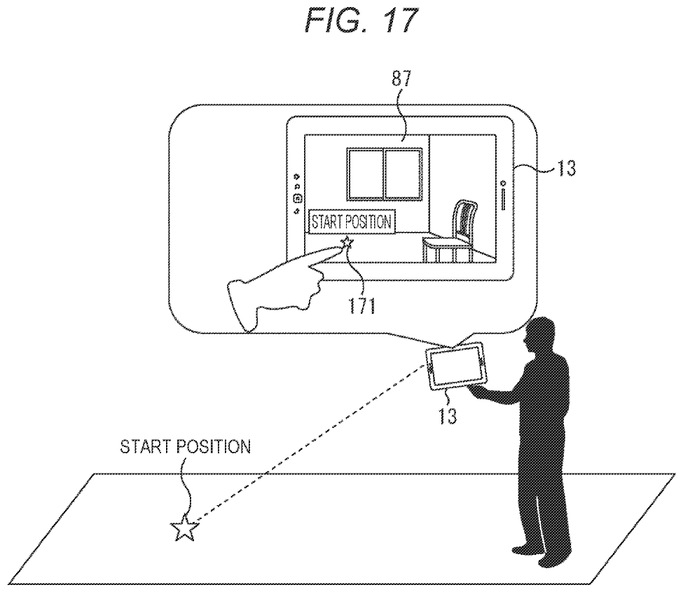

In Step S107 (FIG. 10), it is determined whether or not the start position has been designated. The start position is designated by the user, for example, as illustrated in FIG. 17.

By using the terminal 13, the user captures an image of a place including a position desired as the start position. At this time, the display unit 87 of the terminal 13 displays a part of the room, such as a floor or a wall. The user performs predetermined operation such as touching the floor displayed on the screen. That is, when an image of the position desired as the start position is captured on the display unit 87, the user touches the displayed position (floor) desired as the start position.

When a predetermined position (floor) is touched, for example, a star mark 171 is displayed at the position. The position of the star mark 171 may be changed by the user, and the start position may be adjusted.

When the star mark 171 is displayed, “START POSITION” may be displayed as illustrated in FIG. 17. That is, a display for causing the user to recognize that the start position has been set may be displayed at the position where the star mark 171 is displayed.

By such operation by the user, it is determined in Step S107 whether or not the start position has already been set. In a case where it is determined in Step S107 that the start position has not been designated, the processing proceeds to Step S108.

In Step S108, it is determined whether or not there is a 3D shape map of vicinity of the start position. Even if the start position has been instructed, the start position cannot be specified on the 3D shape map unless a 3D shape map is generated. Therefore, it is determined whether or not a 3D shape map has been generated.

In a case where it is determined in Step S108 that a 3D shape map of the vicinity of the start position has not been generated yet, the processing returns to Step S103, and the subsequent processing is repeated.

By returning the processing to Step S103, a 3D shape map is generated.

Meanwhile, in a case where it is determined in Step S108 that there is a 3D shape map of the vicinity of the start position, the processing proceeds to Step S109. In Step S109, the transport start position is designated. As described with reference to FIG. 17, when the start position is designated by the user via the user interface 72, UI information regarding the designated position is supplied to the start/end position designation unit 78.

Because the 3D shape map is supplied from the map generation unit 81 to the start/end position designation unit 78, it is possible to determine whether or not the 3D shape map of the vicinity of the designated start position has been generated (determination in Step S108) when the start position is designated by the user. Then, in a case where there is a 3D shape map, on the 3D map, the start/end position designation unit 78 generates information about the start position that the user has instructed, for example, coordinates in a three-dimensional coordinate system, and supplies the route plan generation unit 85 with the information.

In this manner, in a case where the start position is designated in Step S109 or in a case where it is determined in Step S107 that the start position has been designated, the processing proceeds to Step S110.

In Step S110, it is determined whether or not an end position has been designated. In a case where it is determined in Step S110 that the end position has not been designated, the processing proceeds to Step S111. In Step S111, it is determined whether or not there is a 3D shape map of vicinity of the end position. In a case where it is determined in Step S111 that there is no 3D shape map of the vicinity of the end position, the processing returns to Step S103, and the subsequent processing is repeated.

Meanwhile, in a case where it is determined in Step S111 that there is a 3D shape map of the vicinity of the end position, the processing proceeds to Step S112. In Step S112, the transport end position is designated.

Processing in Steps S110 to S112 is basically similar to the processing in the case where the start position is designated in Steps S107 to S109. Therefore, as described with reference to FIG. 17, when capturing an image of the place including the end position by using the terminal 13, the user can designate the end position by performing predetermined operation, such as touching a position desired to be designated as the end position in the image displayed on the display unit 87.

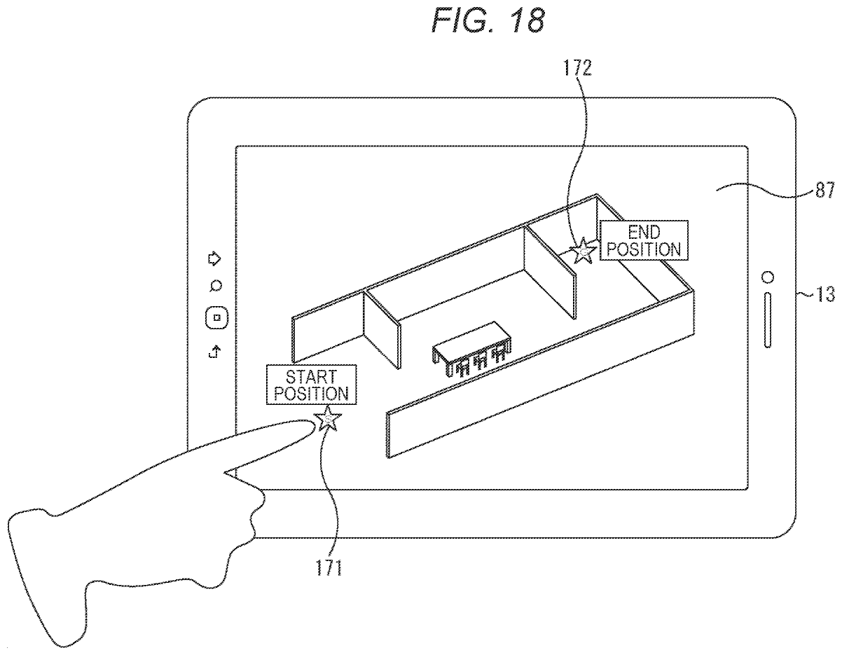

Furthermore, as illustrated in FIG. 18, the start position or/and the end position can be designated. FIG. 18 is a diagram illustrating an example of a screen displayed on the display unit 87 of the terminal 13 when the user designates the start position or/and the end position. The display unit 87 displays a 3D shape map created at that point of time.

When a predetermined position in the 3D shape map is touched, the star mark 171 or a star mark 172 is displayed at the position. The star mark 171 is displayed at the start position, and the star mark 172 is displayed at the end position. In order for the user to more easily recognize which one of the start position or the end position is, as illustrated in FIG. 18, display such as “START POSITION” may be displayed in vicinity of the star mark 171, and display such as “END POSITION” may be displayed in vicinity of the star mark 172.

The start position may be set as described with reference to FIG. 17, and the end position may be set as described with reference to FIG. 18.

Thus, the user can set a start position or an end position while referring to a captured image. Furthermore, the user can also set a start position or an end position while referring to a generated 3D shape map.

In this manner, in a case where the end position is designated in Step S112 or in a case where it is determined in Step S110 that the end position has been designated, the processing proceeds to Step S113.

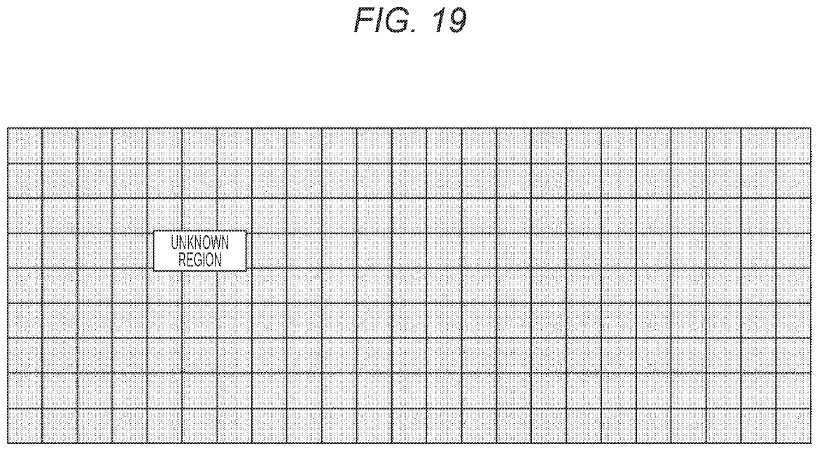

Here, the 3D shape map generated by executing processing in Steps S103 to S112 will be described with reference to FIGS. 19 to 21.

FIG. 19 is a 3D shape map in an initial state. The 3D map in the initial state is a state where an unknown region is designated to overall voxels. Association between the position of the voxels and the terminal 13 at a time of activation can be switched for each mode and depends on implementation. For example, in the case of a route such as a single passage, the position of the terminal 13 at the time of activation can be associated with a left end of the voxels. Furthermore, for example, in a case where there is no restriction or the like, a center of the voxels can be designated as the position of the terminal 13 at the time of activation.

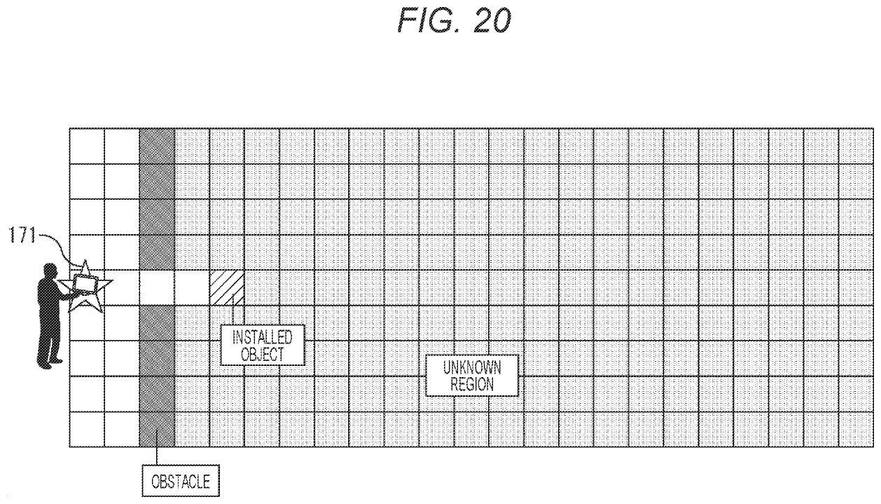

Processing such as generation of a 3D shape map or generation of a 3D label is executed from such a 3D shape map in an initial state. FIG. 20 is a diagram illustrating a state where a 3D shape map of vicinity of the start position is being generated. When generation of the map is started, a blank region and an obstacle region are labeled. The blank region is a region having no obstacle, and the obstacle region is a region having an obstacle. The obstacle is assumed to be an untransportable object such as a wall. In FIG. 20, obstacle regions are shown in black.

As illustrated in FIG. 20, when a start position 171 is designated, the start position 171 can be set on a 3D shape map if a 3D shape map of vicinity of the start position 171 has been generated. However, when the start position 171 is designated, the start position cannot be set on a 3D shape map if a 3D shape map of vicinity of the start position 171 has not been generated, for example in a case where the vicinity of the start position 171 is an unknown region as illustrated in FIG. 19. Therefore, in Step S108 (FIG. 10), when the start position is designated, it is determined whether or not there is a 3D shape map of vicinity of the start position.

A case of an end position 172 is similar to the case of the start position 171, and when the end position 172 is designated, the end position 172 cannot be set on a 3D shape map if a 3D shape map of vicinity of the end position 172 has not been generated, and therefore, it is determined whether or not there is a 3D shape map of the vicinity of the end position when the end position is designated in Step S111 (FIG. 10).

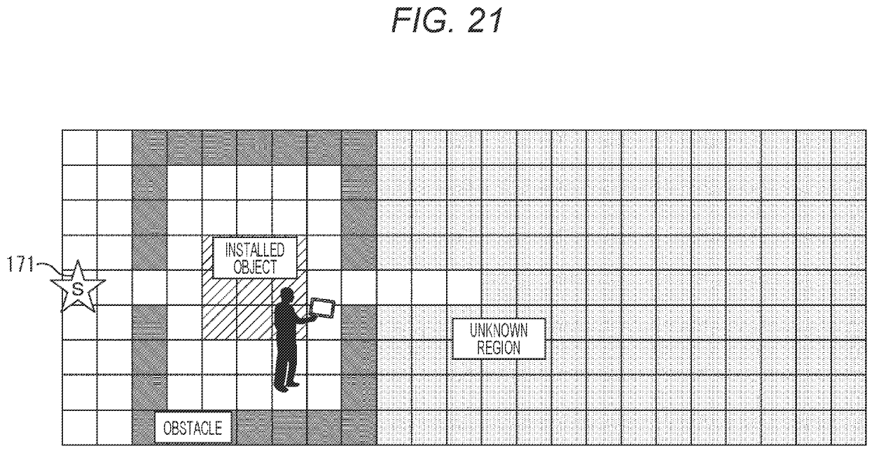

By the processing in Steps S103 to S112 being repeated, an obstacle region and a blank region are allocated, and when an installed object is detected, a 3D label is attached to the installed object. FIG. 21 illustrates a state where a 3D shape map is generated. The 3D shape map illustrated in FIG. 21 is a state where the start position 171 is set, an obstacle and installed objects are detected, and a label is attached. Such a 3D shape map (3D-labeled map) is generated by the processing in Steps S103 to S112 being repeated.

Thus, the unknown region is allocated to a blank region, an obstacle region, or an installed object. The unknown region remaining at a time when the end position is set may be presented when a searched route is presented to the user.

When a route search is performed as will be described later and a route is presented to the user, the unknown region may also be presented to the user. For example, presentation of the unknown region to the user allows the user to judge that additional scanning of an unknown region may search for a better route.

The description will return to the description with reference to the flowchart in FIG. 10. In Step S113, it is determined whether or not route planning is to be started. Here, the route planning is planning for taking an action of transporting the transport target object, and is to search for a transport route as a part of the planning.

The route planning is determined to be started when the following four conditions are met. A first condition is that a mobile object model has been generated. A second condition is that a 3D-shape labeled map has been generated.

A third condition is that a start position is designated. A fourth condition is that an end position is designated. When these four conditions are satisfied, it is determined in Step S113 that the route planning is to be started.

In a case where it is determined in Step S113 that the route planning is not to be started, the processing returns to Step S103, and the subsequent processing is repeated. Meanwhile, in a case where it is determined in Step S113 that the route planning is to be started, the processing proceeds to Step S114.

In Step S114, a route plan is created. A planned (searched) route is a route through which the mobile object model can pass, and is a route through which the mobile object model can pass without hitting a wall, a floor, an installed object, or the like.

An algorithm for searching for a route is an algorithm for judgment of hitting the wall, the floor, the installed object, or the like in consideration of the size of the mobile object model, and for searching for a route from the transport start position to the end position. This algorithm can be constructed with a graph search algorithm. For example, an A* search algorithm can be applied. As the A* search algorithm, a means described in the following Document 3 can be applied.
Document 3: Peter E. Hart; Nils J. Nilsson; Bertram Raphael (July, 1968). “A Formal Basis for the Heuristic Determination of Minimal Cost Paths”. IEEE Transactions on Systems Science and Cybernetics 4 (2): 100-107. doi:10.1109/TSSC.1968.300136. ISSN 0536-1567.

The A* search algorithm is an algorithm that searches for a route by searching for a neighboring point from a center of an attention spot in a search. A route search algorithm can search for a route in a three-dimensional space with an X-axis, a Y-axis, and a Z-axis. In the following description, the description will be continued assuming that an X-Y plane including the X-axis and the Y-axis corresponds to a floor surface, and a direction perpendicular to the floor surface is a Z-axis direction (height direction).

In a route search, the respective X-axis, Y-axis, and Z-axis are treated equally, instead of division in a horizontal direction or vertical direction. However, for each mobile object, there is movable area restriction on the vertical direction (Z-axis direction), and a search is performed within the restricted range. The restriction in the Z-axis direction will be described.

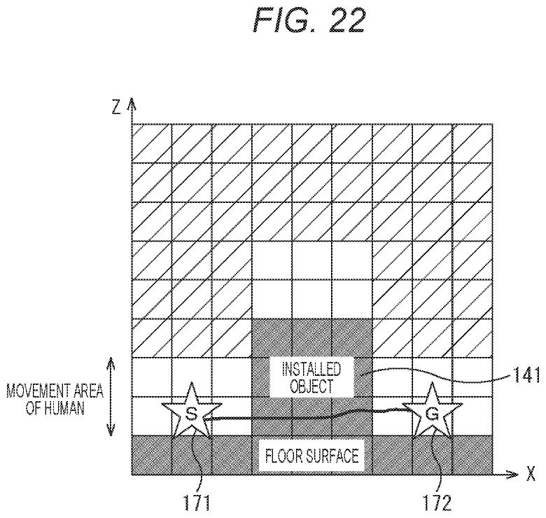

With reference to FIG. 22, restriction in the height direction in a case where a human transports the transport target object will be described. FIG. 22 illustrates an X-Z plane, a floor surface on a lower side of the drawing, and an installed object 141 installed on the floor surface. In a case where a human transports the transport target object, the human cannot move at a position away from the floor surface by a certain distance or more, because the human moves by walking. For example, two squares arranged in the vertical direction illustrated in FIG. 22 are set as a movement area of a human in the vertical direction.

In FIG. 22, parts outside the movement area of a human are indicated by hatching. When a route is searched for, it is set so that the route is not searched for outside the movement area. Therefore, for example, because movement areas of a human are not continuous at the installed object 141, a search for a route is not performed in the Z-axis direction, and a search for the route is performed in a direction in which movement areas of the human are continuous in an X-axis direction and a Y-axis direction.

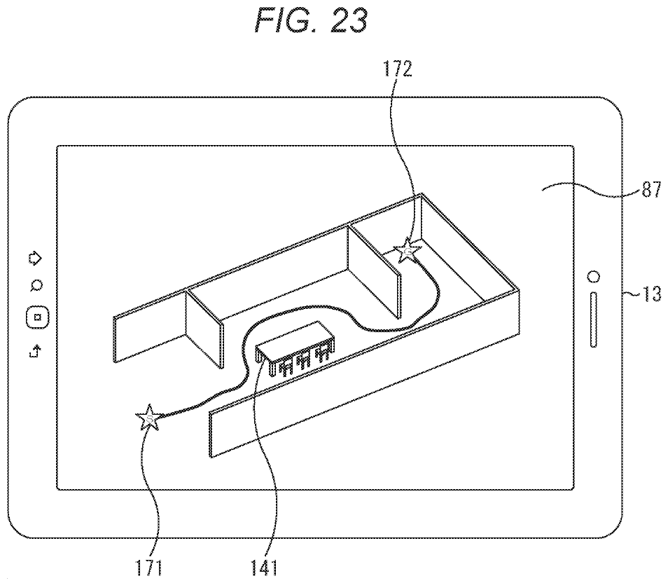

As a result, for example, a route as illustrated in FIG. 23 is searched for and presented to the user. FIG. 23 is a diagram illustrating an example of a route search result displayed on the display unit 87. A 3D shape map and an installed object 141 are displayed on a screen of the route search result. Then, a line connecting the start position 171 and the end position 172 is displayed as a route.

From the screen illustrated in FIG. 23, it can be seen that the route to avoid the installed object 141 is searched for. In a case where a human transports the transport target object, a route to avoid the installed object 141, such as a desk and chairs, is searched for, because the human walks on a floor, that is, the human cannot pass over the installed object 141.

Note that the route is an example, and as will be described later, another route may be set in a case of an installed object to which a label such as a transportable object or a valuable item is attached, and a route more appropriate for the user is searched for.

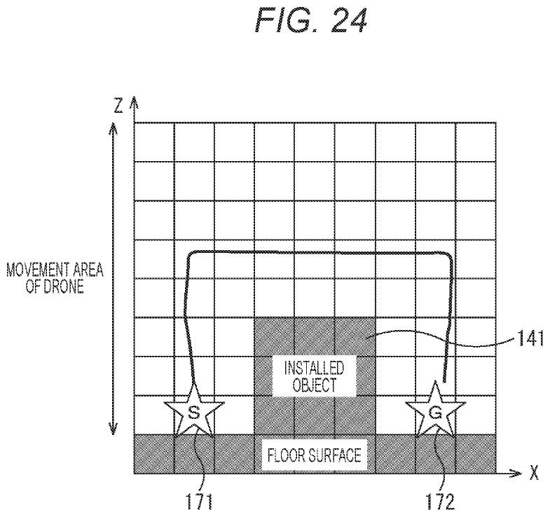

With reference to FIG. 24, restriction in the height direction in a case where a drone transports the transport target object will be described. FIG. 24 illustrates an X-Z plane, a floor surface on a lower side of the drawing, and the installed object 141 installed on the floor surface. This situation is similar to the case illustrated in FIG. 22.

In a case where a drone transports the transport target object, the drone can move even at a position away from the floor surface by a certain distance or more, because the drone moves by flying in air. Therefore, for a drone, a route is set assuming that basically there is no movement area limitation in the vertical direction. There is no hatched region In FIG. 24 as compared to FIG. 23 illustrating an area outside of the movement area of a human, because there is no area outside of a movement area of a drone.

When a route is searched for, it is set so that the route is not searched for outside the movement area. In a case of a drone, for example, because movement areas of the drone are continuous at the installed object 141, a search for a route in the Z-axis direction is performed in a similar manner as a search for a route in the X-axis direction or the Y-axis direction. Therefore, in a case where the route in the Z-axis direction is more suitable than the route in the X-axis direction or the Y-axis direction, the route in the Z-axis direction is searched for even if the route is above the installed object 141, as illustrated in FIG. 24.

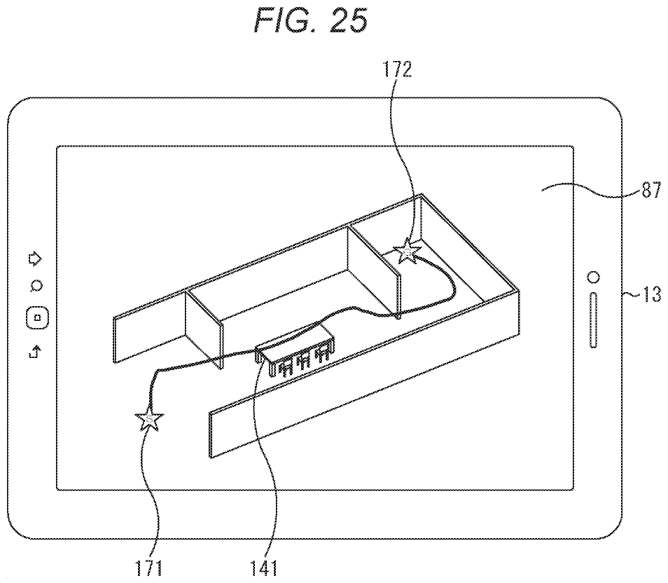

As a result, for example, a route as illustrated in FIG. 25 is searched for and presented to the user. FIG. 25 is a diagram illustrating an example of a route search result displayed on the display unit 87. A 3D shape map and an installed object 141 are displayed on a screen of the route search result. Then, a line connecting the start position 171 and the end position 172 is displayed as a route.

From the screen illustrated in FIG. 25, it can be seen that the route to pass over the installed object 141 is searched for. In a case where a drone transports the transport target object, a route to pass over the installed object 141, such as a desk and chairs, may be searched for, because the drone flies, that is, the drone can pass over the installed object 141.

Note that, in a case where there is a light or the like over the installed object 141, and there is no sufficient space for the drone to pass through, a route for flying over the installed object 141 is not searched for. Although an installed object on a ceiling side is not described for convenience of description, a map of the ceiling side is generated when a 3D shape map or a 3D-shape labeled map is generated, and a route search is performed in consideration of an installed object installed on the ceiling side.

Thus, when a route search is performed, the search is performed in consideration of a movement area that depends on the transport executing object that transports the transport target object. Note that such restriction in the Z-axis direction (altitude direction) can also be set by the user. For example, when the transport target object is precision equipment and therefore is desired to be transported so as not to be shaken up and down, a movement area in the vertical direction (altitude direction) can be set to be narrow.

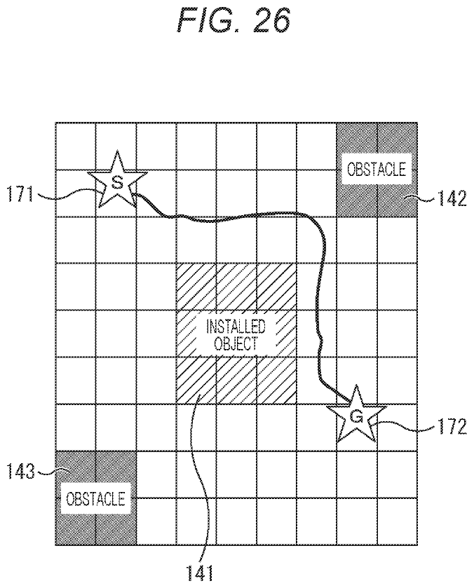

In the route search, a route that does not hit a wall, a floor, an installed object, or the like is determined. A search of a route for not hitting an installed object will be described. As an example, a situation as illustrated in FIG. 26 is considered. Although a search for a route on the X-Y plane will be described In FIG. 26 and subsequent figures, a search in the Z-axis direction is performed similarly to in the X-axis direction and the Y-axis direction, by performing a search within an area of height limitation, or the like, as described above.

FIG. 26 is an example of a 3D shape map, and illustrates a situation in which an installed object 141, an obstacle 142, and an obstacle 143 are installed on a central part, an upper right, and a lower left, respectively. When a route search is performed, a route that avoids (a route that does not hit) the installed object 141, the obstacle 142, and the obstacle 143 is searched for. Furthermore, a route of a shorter distance is basically searched for as the searched route.

Therefore, as indicated by a black line in FIG. 26, in a case where a route from the start position 171 to the end position 172 is searched for, a route that avoids the installed object 141, the obstacle 142, and the obstacle 143 is set. Although a shortest route in terms of distance is a route connecting the start position 171 and the end position 172 with a straight line, there is the installed object 141 on such a route, and therefore a route that avoids the installed object 141 is searched for.

Although a route that avoids the installed object is searched for in this manner basically, a short route that does not avoid the installed object can be searched for according to the present technology. In a 3D-labeled map generated by applying the present technology, information indicating whether or not an installed object is a transportable object is attached to the installed object.

Because a transportable object can be transported, a place of the transportable object may be passed through if the transportable object is transported. Accordingly, because a place of an installed object indicated by a 3D label as a transportable object becomes a region with no installed object (blank region) after the installed object is moved, the place can be treated equally to a region with no installed object.

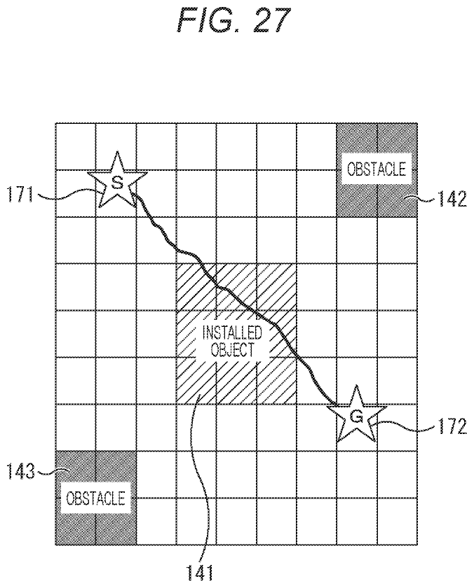

Refer to FIG. 27. Similarly to FIG. 26, FIG. 27 is an example of a 3D shape map, and illustrates a situation in which an installed object 141, an obstacle 142, and an obstacle 143 are installed on a central part, an upper right, and a lower left, respectively. The installed object 141 is an installed object described as a transportable object on a 3D label.

In a situation as illustrated in FIG. 27, a shortest route in terms of distance is a route connecting the start position 171 and the end position 172 with a straight line. Then, although the installed object 141 is installed on the route, because a 3D label indicating a transportable object is attached, it is processed that there is no installed object, and as a result, as illustrated in FIG. 27, a route connecting the start position 171 and the end position 172 with a straight line is treated as a search result.

Thus, by applying the present technology, it is possible to search for even a route that is conventionally not searched for.

Moreover, in addition to the information indicating a transportable object, the 3D label may include information about a level of transportable object. As described above, a level of a transportable object is set according to transportability of the transportable object. Here, description will be continued assuming that an object with a higher level is more transportable, that is, easier to move. For example, a transportable object level 2 represents being easier to move than a transportable object level 1.

For example, the transportable object level 1 is for a piece of heavy furniture such as a chest, the transportable object level 2 is for a piece of furniture that is movable but is not often moved, such as a dining table, and a transportable object level 3 is a piece of furniture that is easy to move, such as a chair.

A transportable object level may be able to be designated by the user via the user interface 72 (FIG. 3). Furthermore, a transportable object level may be designated on the basis of collation between the database 52 (FIG. 3) prepared in advance and a result from the object recognition unit 74 (FIG. 3). There may be a mechanism that is changed by the user after designation in the terminal 13.

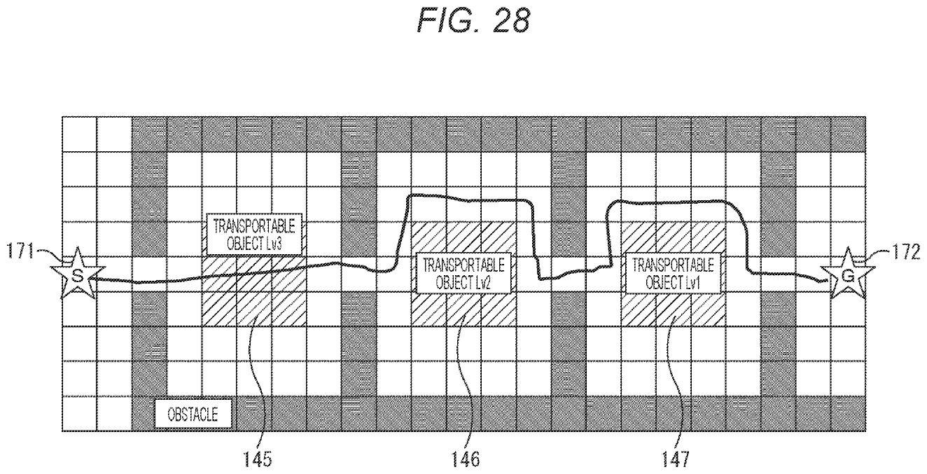

FIG. 28 is a diagram illustrating an example of a 3D-shape labeled map. In the drawing, black squares indicate regions of an obstacle such as a wall that cannot be passed. In the example illustrated in FIG. 28, an installed object 145, an installed object 146, and an installed object 147 are installed in each room. 3D labels indicating a transportable object are attached to these installed objects 145 to 147.

The transportable object level of the transportable object 145 is set to “3”, the transportable object level of the transportable object 146 is set to “2”, and the transportable object level of the transportable object 147 is set to “1”. Whether or not to draw a route on an installed object as a transportable object can be determined according to a transportable object level, and a setting of a transportable object level used for the determination may be set by default or may be set by the user.

FIG. 28 illustrates a case where a transportable object level at which a route is drawn on an installed object as a transportable object is set to the transportable object level 3. In other words, in a case where a condition of being at the transportable object level 3 or higher is satisfied, a set object, which is a transportable object, is treated as being absent from the route search. As referred to FIG. 28, in a search for a movement route from the start position 171 to the end position 172, a shortest route is a route linearly connecting the start position 171 and the end position 172. The installed object 145, the installed object 146, and the installed object 147 are installed on such a linear route.

Because a transportable object level of the installed object 145 is the transportable object level 3, and a transportable object level at which a route is drawn on an installed object as a transportable object is set to be equal to or higher than the transportable object level 3, the installed object 145 is treated as being absent (treated as a blank region), and a route passing through the installed object 145 is also searched for.

Note that the installed object 145 is merely treated as being absent, and a region in which the installed object 145 is present is merely a target region for which a route is to be searched for, and the description does not mean that a route is always drawn on the installed object 145. A route is drawn on the installed object 145 in a case where a route passing through the installed object 145 is optimal, while a route that avoids the installed object is searched for even if the installed object 145 is at the transportable object level 3 in a case where a route that avoids the installed object 145 is optimal. This also applies to the above-described embodiment and embodiments described below.

A route that avoids the installed object 146 is searched for, because a transportable object level of the installed object 146 is the transportable object level 2, and a transportable object level at which a route is drawn on an installed object as a transportable object is set to be equal to or higher than the transportable object level 3.

A route that avoids the installed object 147 is searched for, because a transportable object level of the installed object 147 is the transportable object level 1, and a transportable object level at which a route is drawn on an installed object as a transportable object is set to be equal to or higher than the transportable object level 3.

Thus, according to a transportable object level, a route passing through an installed object is searched for or a route that avoids an installed object is searched for.

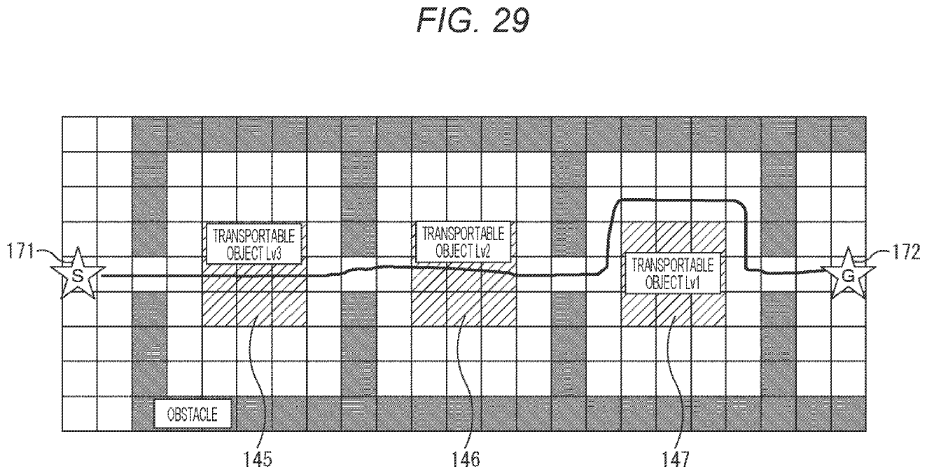

In a case where a transportable object level at which a route is drawn on an installed object as a transportable object is lowered to the transportable object level 2 in the state illustrated in FIG. 28, a route as illustrated in FIG. 29 is drawn.

Because a transportable object level of the installed object 145 is the transportable object level 3, and a transportable object level at which a route is drawn on an installed object as a transportable object is set to be equal to or higher than the transportable object level 2, the installed object 145 is treated as being absent (treated as a blank region), and a route passing through the installed object 145 is also searched for.

Because a transportable object level of the installed object 146 is the transportable object level 2, and a transportable object level at which a route is drawn on an installed object as a transportable object is set to be equal to or higher than the transportable object level 2, the installed object 146 is also treated as being absent (treated as a blank region), and a route passing through the installed object 146 is also searched for.

A route that avoids the installed object 147 is searched for, because a transportable object level of the installed object 147 is the transportable object level 1, and a transportable object level at which a route is drawn on an installed object as a transportable object is set to be equal to or higher than the transportable object level 2.

Thus, according to a transportable object level, a route passing through an installed object is searched for or a route that avoids an installed object is searched for.

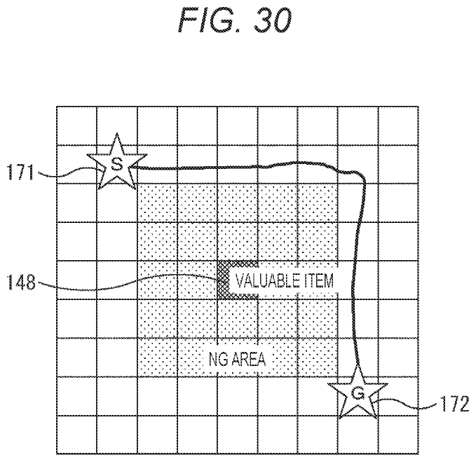

In a case where the installed object is a valuable item, information indicating that the installed object is a valuable item is described on the 3D label. The valuable item is an installed object that is not desired to be broken, damaged, or the like. Therefore, a route that is at least a predetermined distance away from the installed object with a 3D label of valuable item is searched for. Description will be given with reference to FIG. 30.

FIG. 30 illustrates an example of a 3D-labeled map, and a state where an installed object 148 with a 3D label of valuable item is installed at a center. When a route search is performed, a route that avoids (a route that does not hit) the installed object 148 with a 3D label of valuable item is searched for. Moreover, in a case where there is an installed object 148 to which a 3D label of valuable item is attached, a route is searched for in a manner that the route is not drawn on a predetermined area centering on the installed object 148.

In the example illustrated in FIG. 30, an area within two squares (2 voxels where 1 square is 1 voxel) around the installed object 148 with a 3D label of valuable item, that is, a region of 5×5 squares (5×5 voxels), is set as an NG area in which no route can be drawn.

Because a route of a shorter distance is basically searched for as the searched route, a route linearly connecting the start position 171 and the end position 172 is searched for, if the installed object 148 is not present. However, because the NG area is set on the route linearly connecting the start position 171 and the end position 172, a route passing outside the NG area is searched for. Therefore, as indicated by the line in FIG. 30, a route bypassing the NG area is searched for.

A level can also be set for the valuable item. As described above, when searching for a route, a route that is distant from an installed object set as a valuable item is searched for. At a time of the search, the level (hereinafter described as a valuable item level) may be referred to as a condition for setting how far the valuable item and the route are away from each other. Here, description will be continued assuming that a larger NG area is provided for a higher valuable item level.

The valuable item level is set not only by value but also by fragility, feeling of the user, or the like. The valuable item level in association with the installed object may be stored in the database 52 in advance, and the stored value may be set, or may be set by the user.

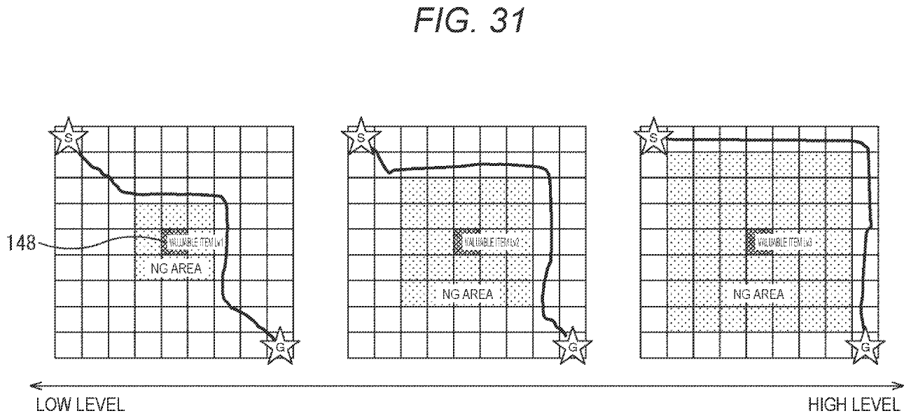

FIG. 31 is a diagram for describing a size of an NG area corresponding to a valuable item level. A left side in the drawing illustrates a case where the valuable item level is at a low level, and a right side in the drawing illustrates a case where the valuable item level is at a high level.

The valuable item level illustrated on the left side in FIG. 31 is a valuable item level 1. In a case of the valuable item level 1, an NG area is an area within one square (1 voxel) around an installed object 148, that is, a region of 3×3 squares (3×3 voxels).

The valuable item level illustrated at a center in FIG. 31 is a valuable item level 2. In a case of the valuable item level 2, an NG area is an area within two squares (2 voxels) around the installed object 148, that is, a region of 5×5 squares (5×5 voxels).

The valuable item level illustrated on the right side in FIG. 31 is a valuable item level 3. In a case of the valuable item level 3, an NG area is an area within three squares (3 voxels) around the installed object 148, that is, a region of 7×7 squares (7×7 voxels).

Thus, a distance away from an installed object as a valuable item is set according to the valuable item level, and a route away by the set distance or more is searched for.

In the above-described route search, a route on which a mobile object model can move is searched for. As described with reference to FIGS. 12 and 13, the mobile object model is a model having a size in consideration of a size of the transport target object and a size of the transport executing object that executes transport of the transport target object. For example, in a case where the transport executing object is a human, volume occupied by the transport target object and the human of when the human lifts the transport target object is a size of the mobile object model.

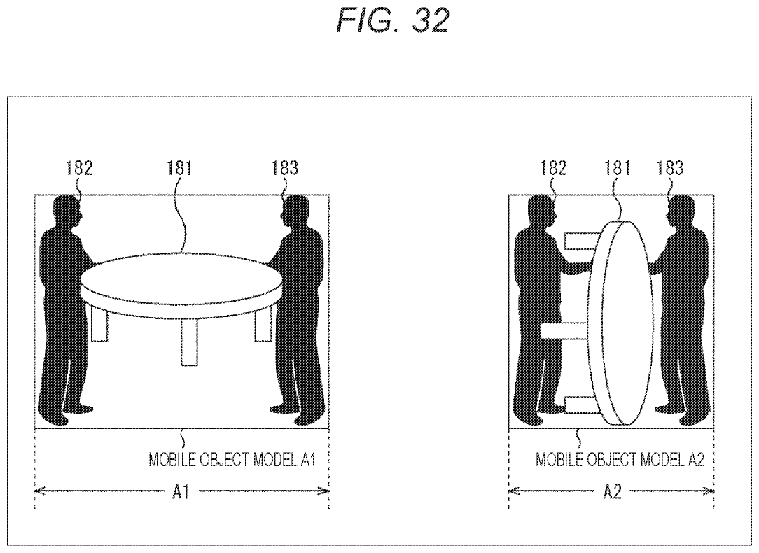

The size of the mobile object model may change depending on how to hold the transport target object. For example, as illustrated in FIG. 32, a case where the transport target object is a desk 181 and the transport executing objects are a human 182 and a human 183 is considered.

A mobile object model A1 is a mobile object model of when the human 182 and the human 183 hold and transport the desk 181 in the horizontal direction. A mobile object model A2 is a mobile object model of when the human 182 and the human 183 hold and transport the desk 181 in the vertical direction. In a case where a horizontal width of the mobile object model A1 is a horizontal width A1 and the horizontal width of the mobile object model A2 is a horizontal width A2, the horizontal width A1 is longer than the horizontal width A2.

Thus, because a size of a mobile object model may change depending on how to hold the transport target object, a plurality of mobile object models with various ways of holding the transport target object may be generated, and, at a time of a route search, an appropriate mobile object model may be selected from among the plurality of mobile object models to search for a route.

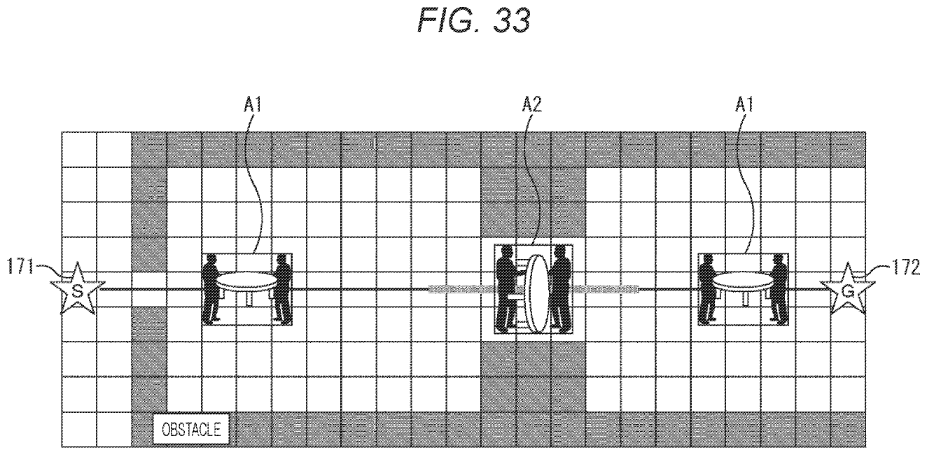

For example, in a case where the mobile object model A1 as a standard is difficult to pass through a route, the mobile object model A2 is planned to pass through the route. An example will be described with reference to FIG. 33.

When a route from the start position 171 to the end position 172 is searched for, a route through which the mobile object model A1 can pass is searched for. On a way, there is a part narrowed by an obstacle (part shown in black in the drawing). It is determined that the mobile object model A1 is difficult to pass through the narrowed part, and may hit the obstacle.

In such a case, it is determined whether or not the mobile object model A2 can pass. Because the mobile object model A2 has a horizontal width narrower than the horizontal width of mobile object model A1, the mobile object model A2 is more suitable than the mobile object model A1 to pass through a narrow place. In a case where the mobile object model A2 can pass without hitting the obstacle, the route is set as a route through which the mobile object model A2 passes.

After passing through the narrow place, a route search for the mobile object model A1 is performed. In a case where such a search is performed, a display that allows the user to understand the search is provided. As illustrated in FIG. 33, for example, the mobile object model A1 and the mobile object model A2 are represented by a picture. The picture is displayed on a route on which the transport target object is recommended to be transported by being held as represented by the picture.

Furthermore, in the example illustrated in FIG. 33, the route on which the mobile object model A2 is recommend to be transported is displayed with a line thicker than a line for a route on which the mobile object model A1 is recommended to be transported. Note that display other than the display examples described herein, such as display in different colors, may be performed.

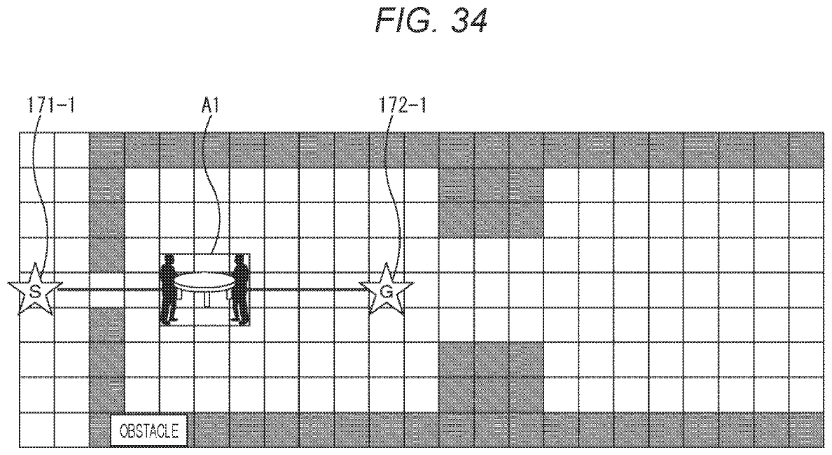

In a case of setting a route in this manner, processing is performed by a flow described with reference to FIGS. 34 to 36. As illustrated in FIG. 34, a start position 171-1 and an end position 172-1 are set. The start position 171-1 is a position set as a transport start position set by the user. The end position 172-1 is a temporary end position for when a route for the mobile object model A1 is searched for. The temporary end position indicates that the position is not an end position set by the user.

A route search from the start position 171-1 to the end position 172-1 is performed in a similar manner to a case described above. Although not illustrated, in a case where there is an installed object labeled as a transportable object, a route is searched for according to the transportable object level, and in a case where there is an installed object labeled as a valuable item, an NG area is set according to the valuable item level, and a route is searched for.

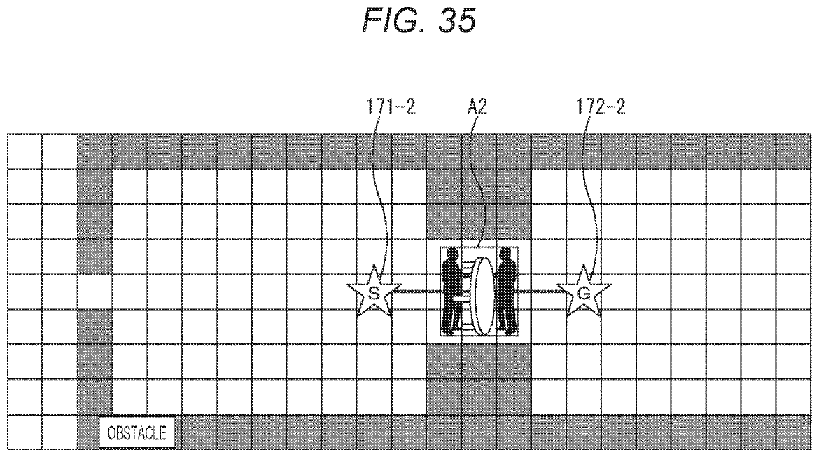

When the route to the end position 172-1 is searched for, as illustrated in FIG. 35, the end position 172-1 is set as a new temporary start position 171-2, and a route from the start position 171-2 is searched for. The route search is performed up to a temporary end position 172-2 set for when the mobile object model A2 is moved. A route search from the start position 171-2 to the end position 172-2 is performed in a similar manner to a case described above.

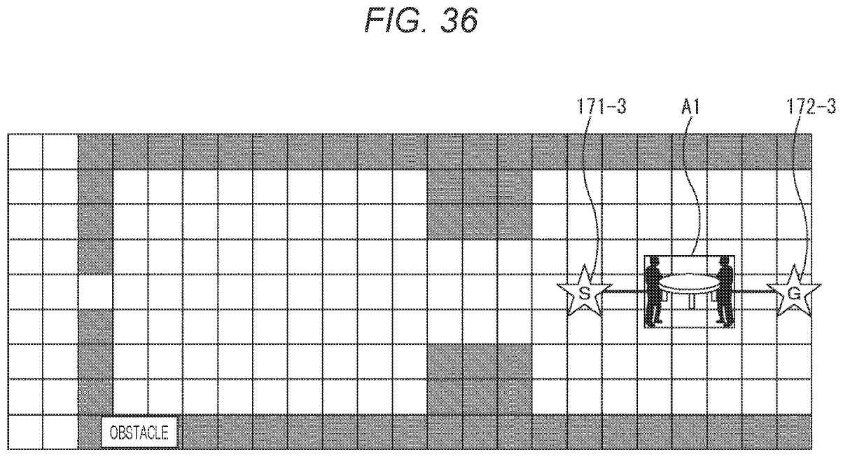

When the route to the end position 172-2 is searched for, as illustrated in FIG. 36, the end position 172-2 is set as a new temporary start position 171-3, and a route from the temporary start position 171-3 is searched for. The route search is performed up to an end position 172-3 set for when the mobile object model A1 is moved. The end position 172-3 is an end position set by the user. A route search from the start position 171-3 to the end position 172-3 is performed in a similar manner to a case described above.

In this manner, a route is searched for while a start position and end position for a route search is set each time a form of the mobile object model changes.

When a route is searched for, the search may be performed in consideration of another piece of information set by the user. The another piece of information set by the user is, for example, a setting of an entry prohibited area.

The entry prohibited area is an area that is not suitable as a transport route due to, for example, a slippery floor that is dangerous to pass through during a transport. Furthermore, the entry prohibited area is a private area that cannot be used as a transport route.

Such an area may be set by the user, and a route search may be performed so that a route is not drawn on the set area.

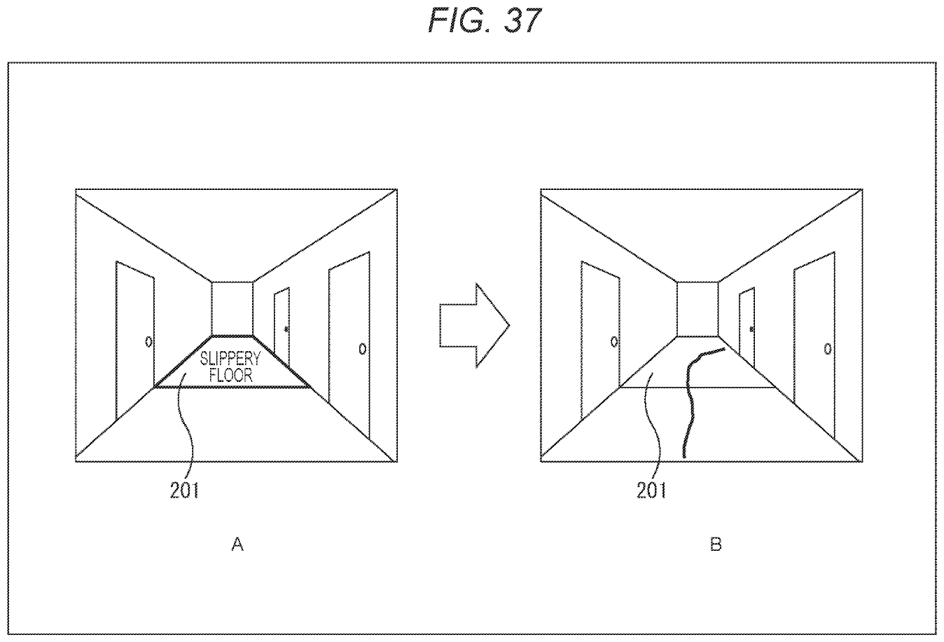

A case where a slippery floor is set as an entry prohibited area will be described as an example with reference to FIG. 37. In the situation as illustrated in A of FIG. 37, it is assumed that a floor on a far side is a slippery floor 201. If the user does not set the floor 201 as an entry prohibited area, there is a possibility that a route is drawn on the floor 201 at a time of a route search, as illustrated in B of FIG. 37.

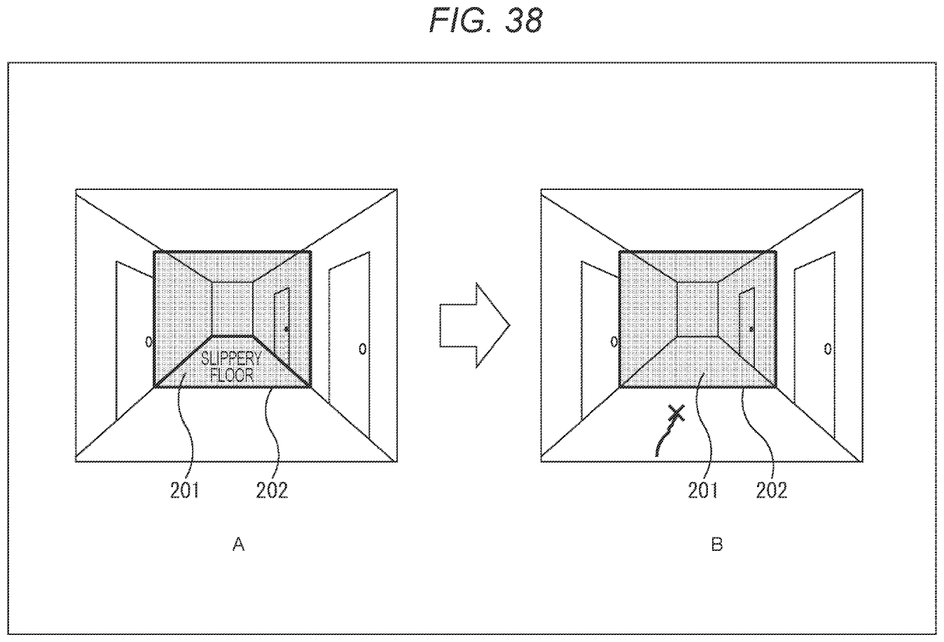

For example, when a screen as illustrated in A of FIG. 37 is displayed on the display unit 87, the user can set an entry prohibited area by performing predetermined operation such as touching four corners of the floor 201. In a case where the user sets the floor 201 as an entry prohibited area, as illustrated in A of FIG. 38, a virtual wall 202 is set so as to prevent from entering the entry prohibited area.

A 3D label indicating prohibition of entry is attached to the virtual wall 202. By setting such a wall 202, as illustrated in B of FIG. 37, a route search is performed such that a route is not drawn on the floor 201.

Thus, the user may set an area in which a route setting is not desired, and may perform control so that a route is not drawn on such an area.

The route plan generation unit 85 (FIGS. 3 and 4) searches for a route in consideration of such various conditions, and supplies the display data generation unit 86 with a movement route. In this manner, when the route plan is created in Step S114 (FIG. 10), the processing proceeds to Step S115.

In Step S115, a CG view of route plan creation or the like is created.

For example, the display data generation unit 86 generates display data for displaying, on the display unit 87, a screen in which a searched route is superimposed on a 3D map as illustrated in FIG. 2, and the display unit 87 performs display on the basis of the display data.

What are displayed on the display unit 87 are a 3D shape map, a transport start position and end position on the 3D shape map, and a route planning result. Moreover, a transportable object level or a valuable item level may also be displayed.

Furthermore, a plurality of routes may be simultaneously displayed. For example, a route that avoids a transportable object and a route that can be passed by moving a transportable object may be simultaneously presented to allow for comparison by the user.

Furthermore, the unknown region may also be displayed. An unknown region may be displayed in a case where it is determined that an optimal route cannot be searched for, or the like, and may be set not to be always displayed. An unknown region may be displayed to prompt the user to perform rescan.

Thus, according to the present technology, it is possible to search for an optimal route for transporting a transport target object and present a route to a user. Furthermore, it is possible to search for a route in consideration of a transportable object, and to present the user with even a route that can be passed by moving the transportable object.

Furthermore, it is possible to search for a route in consideration of a valuable item, and to search for and present the user with a route maintaining a predetermined distance from the valuable item.

Furthermore, by changing a way of holding the transport target object, it is possible to search for and present the user with a place through which the transport target object can pass as a route, or the like.

<Another Method for Route Search and Presentation>

Another method (referred to as a second embodiment) related to a route search and presentation of a searched route will be described.

In the processing based on the flowchart illustrated in FIG. 10 (referred to as the first embodiment), the route planning is started after the end position is set, and therefore the route is presented to the user after the end position is set. As the second embodiment, a case where a route is presented when a user is performing scanning will be described.

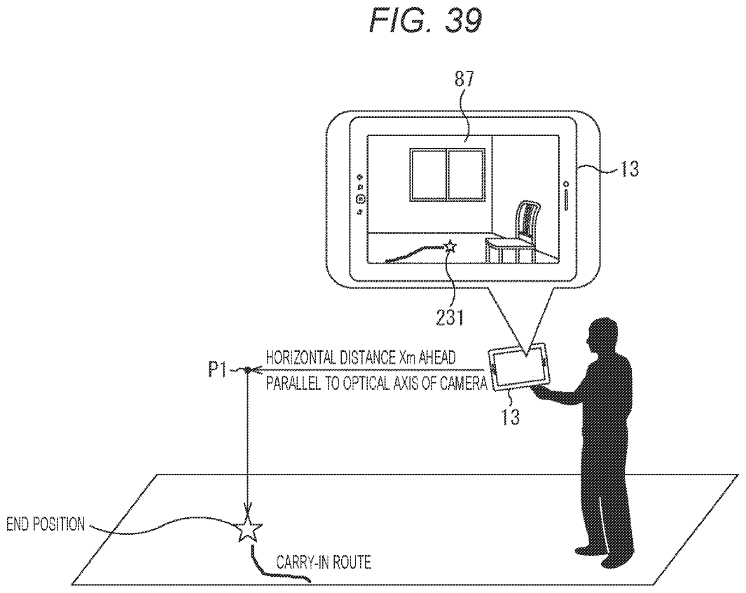

Description will be given with reference to FIG. 39. As in the case of the first embodiment described above, by using a terminal 13, the user is capturing an image of a place to which a transport target object is to be transported. At this time, a display unit 87 of the terminal 13 displays a route (route indicated by a black line in the drawing) that has been searched for up to that point of time, the route being superimposed on a captured image. Furthermore, in order to indicate that the route is a route searched for with respect to a tentatively determined end position, a mark 231 indicating a tentatively determined end position is also displayed.

When a position X m away from the terminal 13 in a direction parallel to an optical axis of a sensor 73 (camera) of the terminal 13 is a point P1, the end position is a position of a voxel immediately below the point P1. The position of the point P1, that is, the position X m away from the terminal 13 may be set by the user, or a preset value may be used. For example, X m is set to 1 m, 2 m, or the like.

Thus, a route may be searched for with respect to the tentatively determined end position, and a search result may be presented to the user. In this case, the user can confirm the route in a real-time basis during scanning.

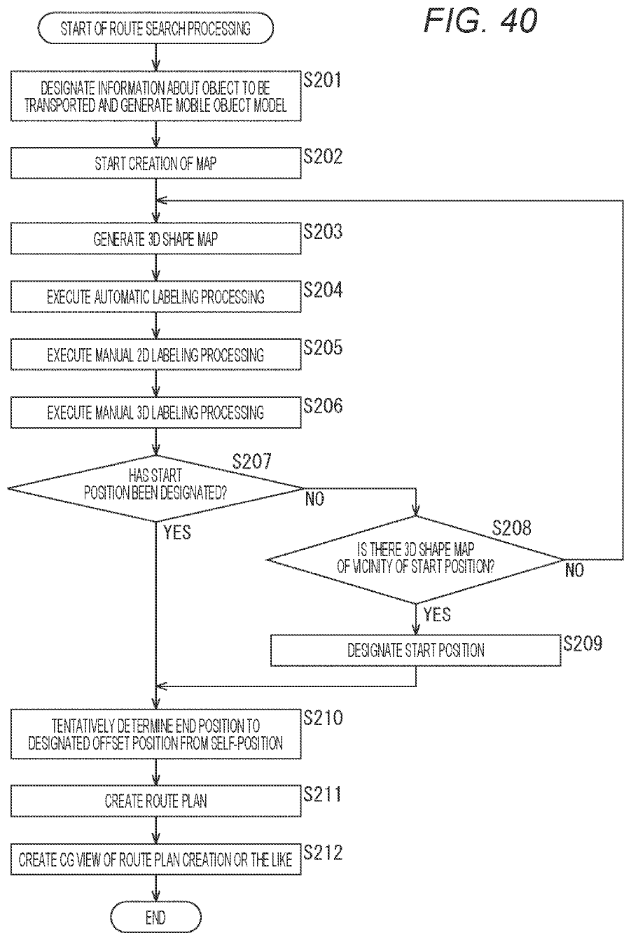

Thus, a configuration of the terminal 13 and server 12 in a case where a route is searched for or presented may be the configuration illustrated in any one of FIGS. 3 to 9. Furthermore, processing can be performed on the basis of the flowchart illustrated in FIG. 40.

The flowchart illustrated in FIG. 40 will be referred to. Because each processing in Steps S201 to S209 can be performed in the same manner as the processing in Steps S101 to S109 (FIG. 10), description thereof will be omitted here to avoid overlap.

In a case where it is determined in Step S207 that the start position has been designated, or the start position is designated in Step S209, the processing proceeds to Step S210.

In Step S210, the end position is tentatively determined to a designated offset position from the self position. That is, as described with reference to FIG. 39, when a position X m away from the terminal 13 in a direction parallel to an optical axis of a sensor 73 (camera) of the terminal 13 is a point P1, a position of a voxel immediately below the point P1 is tentatively determined as the end position.

When the end position is tentatively determined, the processing proceeds to Step S211, and a route plan is created. Then, in Step S212, a CG view of route plan creation or the like is created. Because processing in Steps S211 and S212 can be performed in the same manner as the processing in Steps S114 and S115 (FIG. 10), description thereof will be omitted here to avoid overlap.

According to the second embodiment, in addition to the effects obtained in the first embodiment, it is possible to obtain an effect that the user can perform scanning while keeping confirming a route. Therefore, when a route is examined, it is possible to scan only a place necessary for examining the route while confirming the route, and unnecessary scanning can be reduced.

<Another Configuration Example of Information Processing System>

In the embodiment described above, for example, as illustrated in FIG. 3, a case where one terminal 13 mainly performs processing has been described as an example. Processing may be performed by using a plurality of terminals 13.

For example, in a case where a region for which a route search is desired is wide, it is difficult to perform scanning by one terminal 13 (one user). Described below is a system that allows for, in such a situation, scanning by a plurality of terminals 13 (a plurality of users), is capable of integrating results obtained by the plurality of terminals 13 and searching for a route, and presents the route to the user.

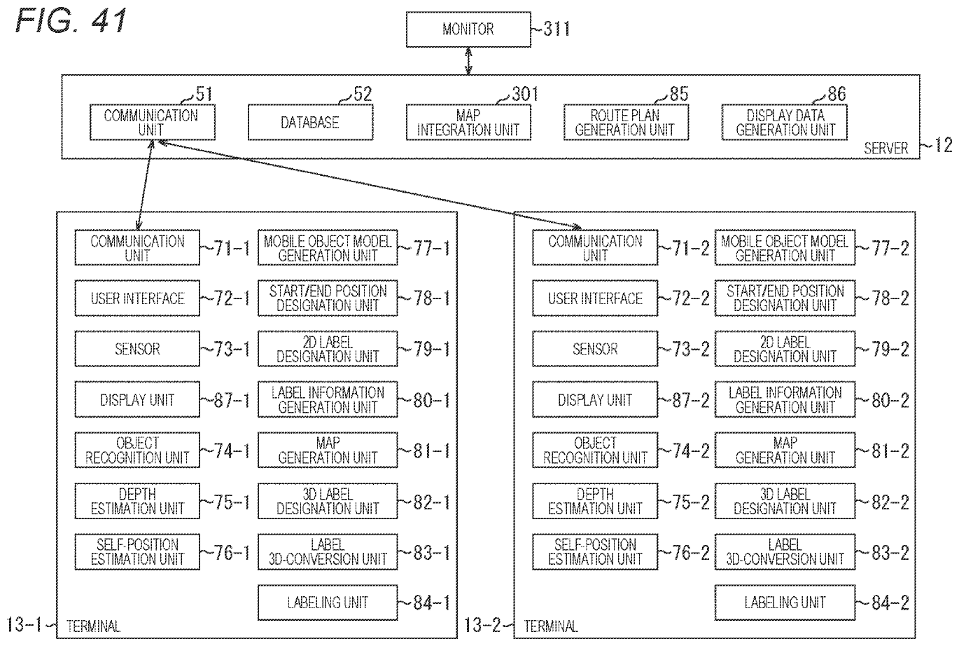

FIG. 41 is a diagram illustrating a configuration example of an information processing system including a plurality of terminals 13 and a server 12. Although two terminals 13-1 and 13-2 are illustrated as a plurality of terminals 13 in FIG. 41, the number of the terminals may be two or more.

The terminal 13-1 and the terminal 13-2 have similar configurations. Furthermore, the terminal 13-1 and the terminal 13-2 have substantially the same configurations as the terminal 13 illustrated in FIG. 5, for example.

The terminal 13-1 includes a communication unit 71-1, a user interface 72-1, a sensor 73-1, an object recognition unit 74-1, a depth estimation unit 75-1, a self-position estimation unit 76-1, a mobile object model generation unit 77-1, a start/end position designation unit 78-1, a 2D label designation unit 79-1, a label information generation unit 80-1, a map generation unit 81-1, a 3D label designation unit 82-1, a label 3D-conversion unit 83-1, a labeling unit 84-1, and a display unit 87-1.

Similarly, the terminal 13-2 includes a communication unit 71-2, a user interface 72-2, a sensor 73-2, an object recognition unit 74-2, a depth estimation unit 75-2, a self-position estimation unit 76-2, a mobile object model generation unit 77-2, a start/end position designation unit 78-2, a 2D label designation unit 79-2, a label information generation unit 80-2, a map generation unit 81-2, a 3D label designation unit 82-2, a label 3D-conversion unit 83-2, a labeling unit 84-2, and a display unit 87-2.

The server 12 includes, similarly to the server 12 illustrated in FIG. 5, a communication unit 51, a database 52, and a route plan generation unit 85. Furthermore, the server 12 illustrated in FIG. 41 includes a display data generation unit 86 and a map integration unit 301.

The server 12 performs processing of integrating data from the plurality of terminals 13. The map integration unit 301 of the server 12 generates one 3D-shape labeled map by integrating a 3D-shape labeled map generated by the labeling unit 84-1 of the terminal 13-1 and a 3D-shape labeled map generated by the labeling unit 84-2 of the terminal 13-2.

To map integration performed by the map integration unit 301, technology described in the following Document 4 filed by the present applicant can be applied.
Document 4: Japanese Patent No. 5471626

The route plan generation unit 85 of the server 12 searches for a route by using a 3D-shape labeled map integrated by the map integration unit 301, a mobile object model from the mobile object model generation unit 77-1 of the terminal 13-1, a start/end position from the start/end position designation unit 78-1 of the terminal 13-1, a mobile object model from the mobile object model generation unit 77-2 of the terminal 13-2, and a start/end position from the start/end position designation unit 78-2 of the terminal 13-2.

A route search performed by the route plan generation unit 85 is performed in a similar manner to a case described above. Information, which is about a route or the like and is generated by the route plan generation unit 85, is supplied to the display data generation unit 86. Processing in the display data generation unit 86 is also performed in a similar manner to a case described above.

The display data generated by the display data generation unit 86 is supplied to the monitor 311. The monitor 311 may be the display unit 87-1 of the terminal 13-1 or the display unit 87-2 of the terminal 13-2. On the monitor 311, a 3D shape map generated on the basis of data obtained from the terminal 13-1 and the terminal 13-2, a searched route, and the like are displayed.

The present technology can also be applied to such a case where a plurality of terminals 13 is used. By using the plurality of terminals 13, it is possible to reduce processing by users who perform the processing using the terminals 13. Furthermore, processing performed by the respective terminals 13 can be reduced.

Note that the present technology can be applied not only to a case of searching for a route of when a transport target object is transported as described above as a matter of course, but also to a case where, for example, an autonomous robot creates a route plan and acts on the basis of the route plan. For example, the present technology can also be applied to a case of searching for a route of when an autonomous robot moves from a predetermined position to a predetermined position, or the like.

<Example of Execution by Software>

By the way, the above-described series of processing can be executed by hardware or can be executed by software. In a case where the series of processing is executed by software, a program included in the software is installed from a recording medium to a computer incorporated in dedicated hardware, a general-purpose computer for example, which is capable of executing various kinds of functions by installing various programs, or the like.

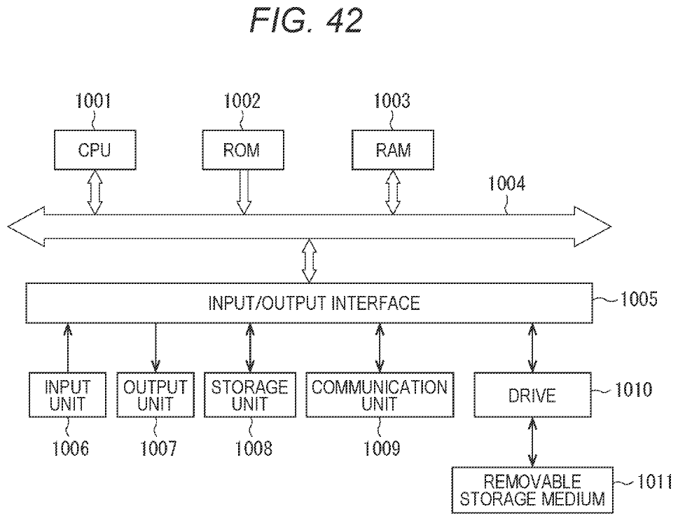

FIG. 42 illustrates a configuration example of a general-purpose computer. The personal computer has a built-in central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005 are an input unit 1006 including an input device such as a keyboard or mouse with which a user inputs an operation command, an output unit 1007 that outputs a processing operation screen or an image of a processing result to a display device, a storage unit 1008 including a hard disk drive or the like that stores a program or various data, and a communication unit 1009 that includes a local area network (LAN) adapter or the like and executes communication processing via a network represented by the Internet are connected. Furthermore, a drive 1010 that reads and writes data from and to a removable storage medium 1011 such as a magnetic disk (including a flexible disk), an optical disc (including a compact disc-read only memory (CD-ROM) and a digital versatile disc (DVD)), a magneto-optical disk (including a mini disc (MD)), or a semiconductor memory is connected.

The CPU 1001 executes various processing according to a program stored in the ROM 1002 or a program read from the removable storage medium 1011 such as a magnetic disk, an optical disc, a magneto-optical disk, or a semiconductor memory, installed in the storage unit 1008, and loaded from the storage unit 1008 to the RAM 1003. As appropriate, the RAM 1003 also stores data necessary for the CPU 1001 to execute various kinds of processing.

In a computer configured as above, the series of processing described above is performed by the CPU 1001 loading, for example, a program stored in the storage unit 1008 to the RAM 1003 via the input/output interface 1005 and the bus 1004 and executing the program.

A program executed by the computer (CPU 1001) can be provided by being recorded on the removable storage medium 1011 as a package medium, or the like, for example. Furthermore, the program can be provided via a wired or wireless transmission medium such as a local area network, the Internet, or digital satellite broadcasting.

In the computer, the program can be installed on the storage unit 1008 via the input/output interface 1005 by attaching the removable storage medium 1011 to the drive 1010. Furthermore, the program can be received by the communication unit 1009 via the wired or wireless transmission medium and installed on the storage unit 1008. In addition, the program can be installed on the ROM 1002 or the storage unit 1008 in advance.

Note that, the program executed by the computer may be a program that is processed in time series in an order described in this specification, or a program that is processed in parallel or at a necessary timing such as when a call is made.

Furthermore, in the present specification, a system represents an entire device including a plurality of devices.

Note that the effects described herein are only examples, and the effects of the present technology are not limited to these effects. Additional effects may also be obtained.

Note that embodiments of the present technology are not limited to the above-described embodiments, and various changes can be made without departing from the scope of the present technology.

Note that the present technology can have the following configurations.

(1)

An information processing device including a processing unit that

generates a mobile object model including an object to be transported and a transport executing object that transports the object, and a three-dimensional shape map of a place to which the object is to be transported, the three-dimensional shape map being based on a captured image of the place,

assigns, on the three-dimensional shape map, a label indicating a property of an installed object installed at the place to a position corresponding to the installed object, and

searches for a route on which the object is to be transported on the basis of the mobile object model, the three-dimensional shape map, and the label.

(2)

The information processing device according to (1),

in which, according to the label, the processing unit searches for a route that avoids the installed object or a route that passes without avoiding the installed object.

(3)

The information processing device according to (1) or (2),

in which the label includes a label indicating a transportable object, and,

in a case where the label attached to the installed object indicates a transportable object, the processing unit searches for the route, assuming that the installed object is absent.

(4)

The information processing device according to (3),

in which the label includes information about a level that represents transportability of the transportable object, and

the processing unit, according to the level indicated by the label attached to the installed object, searches for the route, assuming that the installed object is absent, or searches for a route that avoids the installed object.

(5)

The information processing device according to (4),

in which the processing unit searches for a route from a start position at which transport of the object is started to an end position at which transport of the object is ended, and,

in a case where, during the search, there is an installed object to which a label indicating the transportable object is attached, or in a case where the level satisfies a set condition, searches for a route on the installed object also, assuming that the installed object is absent.

(6)

The information processing device according to any one of (1) to (5),

in which the label includes a label indicating a valuable item, and,

in a case where the label attached to the installed object indicates a valuable item, the processing unit does not search for the route on a position on the three-dimensional shape map to which the label is assigned, and searches for a route outside a predetermined area centering on the installed object.

(7)

The information processing device according to (6),

in which the label further has information indicating a level of a valuable item, and

the processing unit sets the predetermined area according to the level.

(8)

The information processing device according to (7),

in which the processing unit searches for a route from a start position at which transport of the object is started to an end position at which transport of the object is ended, and,

in a case where, during the search, there is an installed object to which the label indicating a valuable item is attached, sets an area corresponding to the level, and searches for a route that passes through outside the set area.

(9)

The information processing device according to any one of (1) to (8),

in which the mobile object model includes a model having a size obtained by adding a size of the object and a size of the transport executing object at a time of the transport executing object transporting the object.

(10)

The information processing device according to any one of (1) to (9),

in which the number of the transport executing objects included in the mobile object model varies depending on weight of the object.

(11)

The information processing device according to any one of (1) to (10),

in which a plurality of the mobile object models is generated according to a method for the transport executing object supporting the object.

(12)

The information processing device according to (11),

in which the processing unit selects, from among the plurality of mobile object models, the mobile object model suitable for a route to be searched, and searches for the route.

(13)

The information processing device according to any one of (1) to (12), the information processing device attaching, in a case where an area in which the route is not searched for is set, a label indicating a virtual wall to the area,

in which, in a region with the label indicating the virtual wall, the processing unit does not search for the route.

(14)

The information processing device according to any one of (1) to (13),

in which the processing unit sets a position a predetermined distance away from a position of the processing unit as an end position at which transport of the object is ended, and searches for a route to the end position.

(15)

The information processing device according to any one of (1) to (14),

in which a start position at which transport of the object is started includes a position instructed by a user with a captured image of a place to which the object is to be transported, or a position designated by the user with the three-dimensional shape map that is displayed.

(16)

The information processing device according to any one of (1) to (15),

in which the label is attached to an installed object instructed by the user with a captured image of a place to which the object is to be transported, or is attached to an installed object designated by the user with the three-dimensional shape map that is displayed.

(17)

The information processing device according to any one of (1) to (16), the information processing device presenting, when the processing unit presents a user with the route searched for, also a region for which the three-dimensional shape map is not generated.

(18)

An information processing method including,

by an information processing device that searches for a route

generating a mobile object model including an object to be transported and a transport executing object that transports the object, and a three-dimensional shape map of a place to which the object is to be transported, the three-dimensional shape map being based on a captured image of the place,

assigning, on the three-dimensional shape map, a label indicating a property of an installed object installed at the place to a position corresponding to the installed object, and

searching for a route on which the object is to be transported on the basis of the mobile object model, the three-dimensional shape map, and the label.

(19)

A program for causing a computer to execute processing including, the computer controlling an information processing device that searches for a route

generating a mobile object model including an object to be transported and a transport executing object that transports the object, and a three-dimensional shape map of a place to which the object is to be transported, the three-dimensional shape map being based on a captured image of the place,

assigning, on the three-dimensional shape map, a label indicating a property of an installed object installed at the place to a position corresponding to the installed object, and

searching for a route on which the object is to be transported on the basis of the mobile object model, the three-dimensional shape map, and the label.

### REFERENCE SIGNS LIST

11 Network
12 Server
13 Terminal
51 Communication unit
52 Database
71 Communication unit
72 User interface
73 Sensor
74 Object recognition unit
75 Depth estimation unit
76 Self-position estimation unit
77 Mobile object model generation unit
78 Start/end position designation unit
79 2D label designation unit
80 Label information generation unit
81 Map generation unit
82 3D label designation unit
83 Label 3D-conversion unit
84 Labeling unit
85 Route plan generation unit
86 Display data generation unit
87 Display unit
111 Transport target object information display field
113 Work field
114 Message display field
131 Installed object
141 Installed object
142 Obstacle
143 Obstacle
151 Frame
161 Frame
171 Start position
172 End position
231 Mark
301 Map integration unit
311 Monitor

1. An information processing device comprising a processing unit that
generates a mobile object model including an object to be transported and a transport executing object that transports the object, and a three-dimensional shape map of a place to which the object is to be transported, the three-dimensional shape map being based on a captured image of the place,
assigns, on the three-dimensional shape map, a label indicating a property of an installed object installed at the place to a position corresponding to the installed object, and
searches for a route on which the object is to be transported on a basis of the mobile object model, the three-dimensional shape map, and the label.

2. The information processing device according to claim 1,
wherein, according to the label, the processing unit searches for a route that avoids the installed object or a route that passes without avoiding the installed object.

3. The information processing device according to claim 1,
wherein the label includes a label indicating a transportable object, and,
in a case where the label attached to the installed object indicates a transportable object, the processing unit searches for the route, assuming that the installed object is absent.

4. The information processing device according to claim 3,
wherein the label includes information about a level that represents transportability of the transportable object, and
the processing unit, according to the level indicated by the label attached to the installed object, searches for the route, assuming that the installed object is absent, or searches for a route that avoids the installed object.

5. The information processing device according to claim 4,
wherein the processing unit searches for a route from a start position at which transport of the object is started to an end position at which transport of the object is ended, and,
in a case where, during the search, there is an installed object to which a label indicating the transportable object is attached, or in a case where the level satisfies a set condition, searches for a route on the installed object also, assuming that the installed object is absent.

6. The information processing device according to claim 1,
wherein the label includes a label indicating a valuable item, and,
in a case where the label attached to the installed object indicates a valuable item, the processing unit does not search for the route on a position on the three-dimensional shape map to which the label is assigned, and searches for a route outside a predetermined area centering on the installed object.

7. The information processing device according to claim 6,
wherein the label further has information indicating a level of a valuable item, and
the processing unit sets the predetermined area according to the level.

8. The information processing device according to claim 7,
wherein the processing unit searches for a route from a start position at which transport of the object is started to an end position at which transport of the object is ended, and,
in a case where, during the search, there is an installed object to which the label indicating a valuable item is attached, sets an area corresponding to the level, and searches for a route that passes through outside the set area.

9. The information processing device according to claim 1,
wherein the mobile object model includes a model having a size obtained by adding a size of the object and a size of the transport executing object at a time of the transport executing object transporting the object.

10. The information processing device according to claim 1,
wherein the number of the transport executing objects included in the mobile object model varies depending on weight of the object.

11. The information processing device according to claim 1,
wherein a plurality of the mobile object models is generated according to a method for the transport executing object supporting the object.

12. The information processing device according to claim 11,
wherein the processing unit selects, from among the plurality of mobile object models, the mobile object model suitable for a route to be searched, and searches for the route.

13. The information processing device according to claim 1, the information processing device attaching, in a case where an area in which the route is not searched for is set, a label indicating a virtual wall to the area,
wherein, in a region with the label indicating the virtual wall, the processing unit does not search for the route.

14. The information processing device according to claim 1,
wherein the processing unit sets a position a predetermined distance away from a position of the processing unit as an end position at which transport of the object is ended, and searches for a route to the end position.

15. The information processing device according to claim 1,
wherein a start position at which transport of the object is started includes a position instructed by a user with a captured image of a place to which the object is to be transported, or a position designated by the user with the three-dimensional shape map that is displayed.

16. The information processing device according to claim 1,
wherein the label is attached to an installed object instructed by the user with a captured image of a place to which the object is to be transported, or is attached to an installed object designated by the user with the three-dimensional shape map that is displayed.

17. The information processing device according to claim 1, the information processing device presenting, when the processing unit presents a user with the route searched for, also a region for which the three-dimensional shape map is not generated.

18. An information processing method comprising,
by an information processing device that searches for a route:
generating a mobile object model including an object to be transported and a transport executing object that transports the object, and a three-dimensional shape map of a place to which the object is to be transported, the three-dimensional shape map being based on a captured image of the place;
assigning, on the three-dimensional shape map, a label indicating a property of an installed object installed at the place to a position corresponding to the installed object; and
searching for a route on which the object is to be transported on a basis of the mobile object model, the three-dimensional shape map, and the label.

19. A program for causing a computer to execute processing comprising, the computer controlling an information processing device that searches for a route:
generating a mobile object model including an object to be transported and a transport executing object that transports the object, and a three-dimensional shape map of a place to which the object is to be transported, the three-dimensional shape map being based on a captured image of the place;
assigning, on the three-dimensional shape map, a label indicating a property of an installed object installed at the place to a position corresponding to the installed object; and
searching for a route on which the object is to be transported on a basis of the mobile object model, the three-dimensional shape map, and the label.
